(19) United States
(12) Patent Application Publication
(10) Pub. No.: US 2006/0199631 A1
(43) Pub. Date: Sep. 7, 2006

(54) Casino games based on financial market activity

(76) Inventors: Bradley J. McGill, Birmingham, AL (US); Andrew D. McGreer, Birmingham, AL (US); Paul Kent Graeve, Paradise Valley, AZ (US)

Correspondence Address: Daniel H. Golub, 1701 Market Street, Philadelphia, PA, 19103, US

(21) Appl. No.: 11/274,882

(22) Filed: Nov. 15, 2005

Related U.S. Application Data
(63) Continuation-in-part of application No. 11/129,853, filed on May 16, 2005.
Application No. 11/129,853 is a continuation-in-part of application No. 11/069,586, filed on Mar. 1, 2005.
(60) Provisional application No. 60/727,569, filed on Oct. 17, 2005.
(60) Provisional application No. 60/627,820, filed on Nov. 15, 2004.

(51) Int. Cl. A63F 13/00

(52) U.S. Cl. 463/16

(57) ABSTRACT

The present invention is directed to a method for conducting a game by a gambling operator or casino in which a plurality of players bet. A set of rules are established for the game, wherein the rules define at least one winner based on at least one financial market data value that fluctuates based on market activity in a financial market that is distinct from the game. Updates to the financial market data value are received electronically from a third-party data source. A forum is electronically coupled to the third-party data source, where the players play the game and bet against a house, in accordance with the established set of rules and the at least one financial market data value. The forum is electronically coupled to one or more third-party market makers who establish odds for the game and provide liquidity for bets of all players. The one or more third-party market makers payout winning bets to one or more winning players based on the established odds, and retain losing bets of one or more losing players.

### CROSS-REFERENCE TO RELATED APPLICATIONS

The present application claims priority to U.S. Prov. App. 60/727,569 filed Oct. 17, 2005, and is a continuation-in-part of U.S. patent application Ser. No. 11/129,853, filed May 16, 2005, entitled “CASINO GAMES BASED ON FINANCIAL MARKET ACTIVITY,” which is a continuation-in-part of U.S. patent application Ser. No. 11/069,586, filed Mar. 1, 2005, entitled “CASINO GAMES BASED ON FINANCIAL MARKET ACTIVITY,” which claims priority to U.S. Prov. App. 60/627,820, filed Nov. 15, 2004, entitled “CASINO GAME BASED ON FINANCIAL INSTRUMENTS AND PARAMUTUAL WAGERING.” Each of the above-referenced applications is hereby incorporated herein in its entirety by reference.

### FIELD OF THE INVENTION

The present invention relates generally to casino games and, in particular, to novel casino and internet skill and chance based games that are derived from activities in financial markets.

### BACKGROUND OF THE INVENTION

Casino gambling is a large and growing industry throughout the world. Various types of betting products and systems exist that facilitate betting on the outcome of a particular game. For example, a patron in a casino may bet on a single hand of blackjack, a pull on a slot machine, a roll of the dice, etc. Typical horse racing bets allow bettors to wager on a single horse, on several horses in a particular race or series of races. For instance, a bettor can wager on a particular horse to finish first (win), finish in the top two (place), or finish in the top three (show). A bettor may also make various combination bets with multiple horses, such as an “exacta” bet (covering the top two horses in order) or a “trifecta” bet (covering the top three horses in order). In addition, a bettor may bet on a series of races, such as the daily double (winners of two consecutive races), the pick-three (winners of three consecutive races), and the pick-six (winners of six consecutive races).

Those betting on other sports may wager, for instance, on various aspects of the outcome of a particular game, including the winning team, the point margin by which that team wins, the combined final score of both teams, and so on. Wagers of this kind are generally well-known and unexceptional. Games or events (the terms “games” and “events” are used interchangeably to connote some probabilistic occurrence) upon which wagers may be placed may be viewed as games of pure chance (e.g., a coin toss or roulette wheel spin assuming the game is a “fair” one with no intervening human or mechanical influence skewing mathematical random distributions of outcome); games of mixed skill and chance (e.g., blackjack or horse racing); or games perceived of as consisting of pure skill (e.g., soccer, chess). All these games and events are believed to be at least somewhat probabilistic in nature. That is, there is more than one possible outcome that is not preordained. Even in games that are perceived as games of pure skill, it is believed that an effectively random element (based on, e.g., weather conditions, unforeseen player injuries, etc.) is almost always present.

Slot machines or other machines for player-initiated games of skill or chance (sometimes referred to as, or including video lottery terminals or video poker games) are becoming increasingly common fixtures in numerous jurisdictions across North America and elsewhere throughout the world. Conventional slot machines have one or more “pay lines” by which to determine whether the spin is a winning one. With each spin, different symbols appear on three or more reels (such as cherries, oranges, bells, or sevens). Preset combinations of symbols on the pay line return predetermined amounts to the player (e.g., three cherries may pay five times the amount wagered). Each spin of the reels generally represents one separate wager.

Online poker represents the symbiosis of two mega trends in gambling, online gambling and poker, and is currently the fastest growing gambling game. Providers of the online poker make their money with a small ‘rake’ from the pot in each game plus, to a lesser extent, tournament fees. What began as triumphant advance in the US is now leading to a global poker wave on the Internet with tremendous potential. The amount gambled on poker websites around the world is estimated to be more than $60 billion in 2005 and industry experts believe that online poker will be the dominant offering in online gambling and that the global annual rake in the 2-3 years will be more than $4 billion. An important reason for the rapid growth of online poker is the increasing number of successful TV shows featuring poker. There are many examples of successful poker TV coverage, among them the World Series of Poker on ESPN, Celebrity Poker on Bravo, and the European Poker Tour on Eurosport. An estimated 50 million Americans currently play poker, but few watched it on TV until the World Poker Tour hit the air in 2003. In Asia, online gaming subscription revenues are projected to more than double by 2008 to $1.84 billion from $760 million in 2003.

Most betting systems of the prior art are similar to a pull on a slot machine or a single hand of black jack in that they are based on the outcome of a single event or game—a “one-off transaction.” An exception may be found in certain progressive or “jackpot” slot machine systems. The progressive jackpot is made by taking a small percentage of all money played into a machine. The jackpot continues to grow as more people play the machine until a player hits the winning symbols for the progressive jackpot. Not all progressive machines are the same. There are actually three different types of progressive machines. The first type is the stand alone progressive machine, which is not linked to any other machines. The stand alone progressive machine takes a percentage of the coins played and adds that to the pot for the eventual progressive jackpot winner. The second type corresponds to in-house or proprietary progressive jackpot machines, which are a group of machines linked together and owned and operated by the casino where the machines are physically located. The third type is wide area progressive jackpot machines. These machines are linked together from many unrelated casinos, and are operated by an independent operator rather than a single casino. The casino shares in a percentage of the winnings but the operator owns the games. The casino and the independent operator, in the case of wide area progressive jackpots, take a fee off of the top of the progressive jackpot before it is paid out to the winner.

There are basically three types of payouts in casino games. The first is a pooled payout where the winner(s) of the game are paid the total pool of bets from the other players in the game, minus a fee for the house called a rake. A common example of a pooled payout game is poker, where the winner of each poker hand (game) receives the total pot bet by the players they beat. The second is a pari-mutuel payout where the winners are paid based on the odds that are calculated from the bets that are placed by the players in the game. In a pari-mutuel payout game the odds are calculated using high-speed electronic calculators, known as totalizators or tote boards, to calculate the odds as bets are placed and display the up-to-the-minute odds to the players. Similar to the pooled payout, in a pari-mutuel payout game, the winners share the total amount bet from the losers in the game minus a fee for the house. Thus, the uniqueness of both pooled and pari-mutuel payout games is that the players themselves determine the payout. A common example of gambling in a pari-mutuel format is sports betting where the winners are paid according to the odds established by the bets before the sporting event begins. The third type of payout is based on odds established by the house. In such a game the house pays the player when they win, and take the players bet when they lose, and typically the player simply keeps their bet if they tie the house in the game. The odds, and thus the payout to the player when they win is known by the house, and may, or may not, be known to the player. Typically the odds will be set by the house so the house has an advantage and thus over time and numerous bets the house will win more money than the players. A common example of a house payout game is blackjack where the player wins money from the house when their hand beats the house's hand, but the house takes the players money when the house's hand beats the player's hand.

Like gambling, interest in world financial markets has grown significantly in recent years. An increasing number of small individual investors participate in these markets, and there is a growing interest among the population as to how such markets function. In addition to equities, trading in derivatives and other sophisticated financial products has matured, and new types of financial products such as exchange traded funds and hedge funds are being introduced.

Despite the growing popularity of both casino gambling and financial markets, these concepts have not previously been integrated in casino games. The present invention addresses this shortcoming in the prior art, and is directed to novel casino games that are based on activity in financial markets.

### SUMMARY OF THE INVENTION

The present invention is directed to a method for conducting a game by a gambling operator or casino in which a plurality of players bet. A set of rules are established for the game, wherein the rules define at least one winner based on at least one financial market data value that fluctuates based on market activity in a financial market that is distinct from the game. Updates to the financial market data value are received electronically from a third-party data source. A forum is electronically coupled to the third-party data source, where the players play the game and bet against a house, or in a pari-mutuel format, in accordance with the established set of rules and the at least one financial market data value. The forum is electronically coupled to one or more third-party market makers who establish odds for the game and provide liquidity for bets of all players. The one or more third-party market makers payout winning bets to one or more winning players based on the established odds, and retain losing bets of one or more losing players. In some embodiments, the financial market data value corresponds to a value of a financial market instrument selected from the group consisting of: a stock, option, future, fund, bond or physical commodity. Alternatively, the financial market data value may correspond to an interest rate, index, exchange rate, or data release.

The forum where the game is played may correspond to a casino where all of the players are physically present during the game. Alternatively, the forum may correspond to an on-line forum that includes a computer network that permits communication among physically separated players during the game.

In accordance with one aspect, the present invention is directed to an apparatus for conducting a game of chance. The apparatus includes a machine that accepts a wager from a player. The machine receives live financial market data. A display coupled to the machine shows the current value of a security, market index, economic or financial market indicator, foreign exchange rate, physical commodity or interest rate, wherein the current value includes at least four digits. A random number generator generates at least four random digits that are shown on at least one row of the display when digits on the display spin. In one embodiment, the machine pays the player a jackpot if at least one of the random digits shown on the at least one row matches a digit representing the current value of the security, market index, economic or financial market indicator, foreign exchange rate, physical commodity or interest rate, when the digits on the display stop spinning; otherwise, the machine retains the wager. Alternatively, the machine pays the player a jackpot if at least one of the random digits shown on a specific one or ones of the rows matches a digit representing the current value of the security, market index, economic or financial market indicator, foreign exchange rate, physical commodity or interest rate, when the digits on the display stop spinning; otherwise, the machine retains the wager. In another embodiment, in order for there to be a payout, there must be positional correspondence between at least one of the random digits shown on the at least one row and a digit representing the current value of the security, market index, economic or financial market indicator, foreign exchange rate, physical commodity or interest rate, when the digits on the display stop spinning. In still further embodiments, the payout may be progressively higher as more digits are matched. The machine may randomly select the security, market index, economic or financial market indicator, foreign exchange rate, physical commodity or interest rate for the player or, alternatively, the machine may include an input that permits selection of the security, market index, economic or financial market indicator, foreign exchange rate, physical commodity or interest rate by the player. The machine may be a physical slot machine located in a casino, or a virtual slot machine implemented on-line over a computer network using, for example, a remote client computer accessed by the player and a server connected to the client computer over the computer network.

In accordance with a further aspect, the present invention is directed a machine that accepts wagers from a plurality of players betting on a race, and assigns a security, market index, economic or financial market indicator, foreign exchange rate, physical commodity or interest rate, to each player. The machine receives live financial market data. A display coupled to the machine shows a plurality of securities, market indices, economic or financial market indicators, foreign exchange rates, physical commodities or interest rates, assigned to the players. In one embodiment, the machine determines a winning security, market index, economic or financial market indicator, foreign exchange rate, physical commodity or interest rate, using the live financial market data, by identifying the security, market index, economic or financial market indicator, foreign exchange rate, physical commodity or interest rate shown on the display that increases in value the most by percentage during the race, which lasts a fixed period of time. At the end of the race, the machine pays winnings to each player assigned to the winning security, market index, economic or financial market indicator, foreign exchange rate, physical commodity or interest rate. In one embodiment, the machine accepts combination bets (e.g., exactas, trifectas, daily double, pick three and pick six) from each player. The machine may be a physical machine located in a casino, or a virtual machine implemented on-line over a computer network using remote client computers accessed by the players and a server connected to the client computers over the computer network.

In accordance with a still further aspect, the present invention is directed to a machine that accepts wagers from one or more players of a game. A port in the machine receives live financial market data, and a display coupled to the machine shows a value of a security, market index, economic or financial market indicator, foreign exchange rate, physical commodity or interest rate, during a countdown period of the game. The display also shows a plurality of value ranges for the security, market index, economic or financial market indicator, foreign exchange rate, physical commodity or interest rate, and odds for each value range. Each wager accepted by the machine corresponds to a selected one of the plurality of value ranges. The machine determines a winning value range using the live financial market data by identifying the value range that the security, market index, economic or financial market indicator, foreign exchange rate, physical commodity or interest rate is within at the end of the game. The machine pays winnings at the end of the game, in accordance with the odds, for each wager having a selected value range corresponding to the winning value range. In some embodiments, the machine accepts wagers for more than one value range from a single player. This game can be configured as a game of skill where (i) the security, market index, economic or financial market indicator, foreign exchange rate, physical commodity or interest rate and/or (ii) the selected value range are selected by the player; alternatively, the game could be implemented as a game of chance where all such choices are made at random by the machine or a gambling operator or casino. Again, the machine may be a physical machine located in a casino, or a virtual machine implemented on-line over a computer network using remote client computers accessed by the players and a server connected to the client computers over the computer network.

In accordance with a further aspect, the present invention is directed to a machine for conducting a game of skill. The machine accepts wagers from a plurality of players betting on a race, and a port in the machine receives live financial market data. A display coupled to the machine shows a plurality of securities, market indices, economic or financial market indicators, foreign exchange rates, physical commodities or interest rates, and streaming financial data for each of the securities, market indices, economic or financial market indicators, foreign exchange rates, physical commodities or interest rates during a countdown period. Wagers are accepted during the countdown period, and each of the wagers corresponds to one or more of the plurality of securities, market indices, economic or financial market indicators, foreign exchange rates, physical commodities or interest rates selected by a player (using the player's skill). The machine determines a winning security, market index, economic or financial market indicator, foreign exchange rate, physical commodity or interest rate at the end of the race, using the live financial market data, by identifying the security, market index, economic or financial market indicator, foreign exchange rate, physical commodity or interest rate shown on the display that increases (or decreases, in alternate embodiments) in value the most by percentage during the race. At the end of the race, the machine pays winnings on each wager that corresponds to the winning security, market index, economic or financial market indicator, foreign exchange rate, physical commodity or interest rate. In one embodiment, the machine accepts combination bets (e.g., exactas, trifectas, daily double, pick three and pick six) from each player. The machine may be a physical machine located in a casino, or a virtual machine implemented on-line over a computer network using remote client computers accessed by the players and a server connected to the client computers over the computer network.

In accordance with s still further aspect, the present invention is directed to conducting a game that uses a deck of cards, wherein each card in the deck is associated with a symbol corresponding to one of a defined list of possible securities, market indices, economic or financial market indicators, foreign exchange rates, physical commodities or interest rates. An ante wager is received from each player in the game. After receipt of the ante wager from each player, a portfolio is assigned to each player and the house by dealing a plurality of cards from the deck to each player and the house, respectively. After the cards are dealt, a betting round occurs during where each player is permitted to fold or raise their wager in the game. After the betting round, streaming financial data provided to the game is used to monitor a percentage increase (or decrease) in value in the portfolio of each player and the portfolio of the house during a race. At the end of the race, a player remaining in the game wins if the player has a portfolio that increased by percentage more than the portfolio of the house. In some embodiments, the cards are dealt face-down to the players, and at least one card is dealt face-up to the house. In other embodiments, a player places a side bet against one or more other players. The game may be played on a physical table located in a casino, or on-line over a computer network using remote client computers accessed by the players and a server connected to the client computers over the computer network.

In accordance with yet a further aspect, the present invention is directed to a machine that accepts wagers from at least one player, wherein the wager is associated with a given security, market index, economic or financial market indicator, foreign exchange rate, physical commodity or interest rate, and includes a selected direction for a value of the given security, market index, economic or financial market indicator, foreign exchange rate, physical commodity or interest rate, and a number of consecutive predefined periods in which the value of the given security, market index, economic or financial market indicator, foreign exchange rate, physical commodity or interest rate will move in the selected direction. A port in the machine receives live financial market data. A display coupled to the machine shows streaming financial data for the given security, market index, economic or financial market indicator, foreign exchange rate, physical commodity or interest rate. The machine uses the live financial market data to monitor the value of the given security, market index, economic or financial market indicator, foreign exchange rate, physical commodity or interest rate during the game, and pays winnings to the player if, during each of the consecutive predefined periods associated with the wager, the value of the given security, market index, economic or financial market indicator, foreign exchange rate, physical commodity or interest rate, moves in the selected direction associated with the wager. This game can be configured as a game of skill where (i) the security, market index, economic or financial market indicator, foreign exchange rate, physical commodity or interest rate, (ii) the selected price direction, and (iii) the number of consecutive periods are selected by the player; alternatively, the game could be implemented as a game of chance where all such choices are made at random by a machine provided by a gambling operator or casino. Again, the machine may be a physical machine located in a casino, or a virtual machine implemented on-line over a computer network using a remote client computer accessed by the player and a server connected to the client computer over the computer network.

In accordance with yet a further aspect, the present invention is directed to a method for conducting a game where a gaming sponsor provides a forum where each player plays against other players. Each player privately predicts before a round what a closing value of a given security, market index, economic or financial market indicator, foreign exchange rate, physical commodity or interest rate will be at the end of the round. After making their private prediction, and during the round, each player has an opportunity to bet into a pot or fold. A player wins some or all of the pot if, at the end of the round, (i) the private prediction of the player is closer to the closing value than any private prediction of any other player in the game, or (ii) all other players have folded. In some embodiments, players whose price predictions are the second and third closest to the actual closing value receive lesser amounts from the pot. In a still further variant, during the round, each player can buy a right to make a small change to their private prediction by adding a certain amount to the pot. In a yet further embodiment, a player may place a side bet against one or more other players. The game may be played on a physical table located in a casino, on-line over a computer network using remote client computers accessed by the players and a server connected to the client computers over the computer network, or any other suitable forum provided by a gaming sponsor.

In accordance with a still further aspect, the present invention is directed to a method for conducting a game where each player plays against other players. A deck of cards is provided, wherein each card in the deck is associated with a symbol corresponding to one of a defined list of possible securities, market indices, economic or financial market indicators, foreign exchange rates, physical commodities or interest rates. An ante wager is received from each player. After receipt of the ante wager from each player, a portfolio is assigned to each player by dealing a plurality of cards from the deck to each player. After the cards are dealt, a betting round is provided where each player is permitted to bet into a pot or fold. After the betting round, streaming financial data provided to the game is used to monitor a percentage increase in value in the portfolio of each player. Some or all of the pot is awarded to a player if, at the end of a predetermined period, the portfolio assigned to the player increased in value by percentage more than the portfolio of any other remaining player in the game or all other players have folded. In some variants, some of the cards are dealt face-up, whereby a portion of each player's portfolio is revealed to the other players in the game. In other variants, some of the pot is awarded to a player if, at the end of the predetermined period, the portfolio assigned to the player increased in value by percentage less than the portfolio of any other remaining player in the game. The game may be played on a physical table located in a casino, on-line over a computer network using remote client computers accessed by the players and a server connected to the client computers over the computer network, or any other suitable forum provided by a gaming sponsor or gambling operator.

In yet a further embodiment, the present invention is directed to a method for conducting a game of skill where each player plays against other players. An ante wager is received from each player, and a portfolio selection is received from each player, wherein the portfolio selection includes a plurality of securities, market indices, economic or financial market indicators, foreign exchange rates, physical commodities or interest rates, selected from a set of possibilities fixed by the house. After the portfolio selection is made by each player, a betting round is provided where each player is permitted to bet into a pot or fold. After the betting round, streaming financial data provided to the game is used to monitor a percentage increase in value in the portfolio of each player. Some or all of the pot is awarded to a player if, at the end of a predetermined period, the portfolio selected by the player increased in value by percentage more than the portfolio of any other remaining player in the game or all other players have folded. A portion of each player's portfolio may be revealed to the other players in the game during or before the betting round. In one variant, some of the pot is awarded to a player if, at the end of the predetermined period, the portfolio selected by the player increased in value by percentage less than the portfolio of any other remaining player in the game. The game may be played on a physical table located in a casino, on-line over a computer network using remote client computers accessed by the players and a server connected to the client computers over the computer network, or any other suitable forum provided by a gaming sponsor.

### BRIEF DESCRIPTION OF THE DRAWINGS

FIG. 1 illustrates a forum for conducting a casino game in accordance with the present invention, wherein the players are physically present in a common location during the game.

FIG. 2 illustrates an on-line forum for conducting a casino game in accordance with the present invention, wherein the players are physically separated from each other during the game.

FIG. 3 is a screen shot illustrating an exemplary implementation of the “Wall Street Match 4” game of the present invention.

FIG. 4 is a screen shot illustrating an exemplary implementation of the “Wall Street Racing” game of chance, in accordance with the present invention.

FIG. 5A is a screen shot illustrating an exemplary implementation of the countdown period of the “Wall Street Rangers” game of the present invention.

FIG. 5B is a screen shot illustrating an exemplary implementation of the “Wall Street Rangers” game of the present invention during the duration of the game.

FIG. 5C is a screen shot illustrating an exemplary interface for used in the “Wall Street Rangers” game of the present invention during the mid-point of the game for providing players the option to surrender or double down.

FIG. 6A is a screen shot illustrating an exemplary implementation of the countdown period of the “Wall Street Racing” game of skill, in accordance with the present invention.

FIG. 6B is a screen shot illustrating an exemplary implementation of the “Wall Street Racing” game of skill during the duration of the game.

FIG. 6C is a screen shot illustrating an exemplary interface for accepting wagers in the “Wall Street Racing” game of skill according to the present invention.

FIG. 7 illustrates an exemplary table layout of the “Wall Street 2-Cards” game, in accordance with the present invention.

FIG. 8A is a screen shot showing an exemplary user interface for accepting wagers in the “Bull Run” game of the present invention.

FIG. 8B is a screen shot showing the user interface of FIG. 8A during the playing of the “Bull Run” game of the present invention.

FIG. 8C is a screen shot showing the user interface of FIG. 8A during a pre-game period of the “Bull Run” game of the present invention.

FIG. 8D illustrates an exemplary table layout of the “Bull Run” game, in accordance with the present invention.

FIG. 9A is a screen shot illustrating an exemplary main game display for implementing the “Portfolio” game, in accordance with the present invention.

FIG. 9B is a screen shot illustrating an exemplary personal game display for implementing the “Portfolio” game, in accordance with the present invention.

FIG. 9C is a screen shot of an exemplary display illustrating each player's initial two-stock combined totals, in accordance with the “Porfolio” game of the present invention.

FIG. 9D is a screen shot of an exemplary display illustrating each player's third and fourth stock picks, in accordance with the “Porfolio” game of the present invention.

### DETAILED DESCRIPTION OF THE PREFERRED EMBODIMENTS

The present invention includes methods and systems for creating and playing casino games that can be played in a physical gaming room or online, where the players bet, and the elements of the game consist of, for example, actual financial instruments that are traded on various financial exchanges around the world, or other financial data representative of the state of one or more financial markets. Financial data values that could be used in the games include any of the following: the values of financial securities, market indices, economic data or indicators, financial market data and indicators, foreign exchange rates, physical commodities and interest rates. Financial instruments which trade constantly, in significant volume, with higher than average volatility will be most attractive for use in these games as they will provide short-term movements that will keep the games exciting and fast-paced. Although in the description below, various embodiments of the present invention are described as being based on the use of financial instruments, it will be understood that each of these embodiments may be based on any financial data value such as the ones listed above.

The casino games of the present invention optionally combine elements, rules and strategies traditionally found in casino games and betting with strategies traditionally utilized in financial investing; thereby attracting players with knowledge and skills in both gambling and investing. In addition, since the players are betting against each other, or the house, and not against the overall financial markets as a whole, the games have particular appeal to players who believe, for one reason or another, that they possess superior knowledge or skill in the financial markets. Moreover, depending upon the odds of the bet placed by the player, a financial gambling player could win a relatively substantial amount of money from a relatively small winning bet based on a tiny change, or even no change in a financial data point; something not reasonably possible by investing in the actual financial markets. For example, in a pari-mutuel payout financial gambling game, a player betting that a historically volatile financial data point will not change during the course of a game could win a substantial amount of money given the odds the historically volatile instrument would in fact change during the course of the game would be substantial.

In various embodiments of the present invention, the players play the game and bet against the house. In such embodiments, the gambling forum may be electronically coupled to one or more third-party market makers who establish odds for the game and provide liquidity for bets of all players. The third-party market maker(s) payout winning bets to winning players based on the established odds, and retain losing bets of losing players. The third-party market maker(s) provide liquidity by ensuring that all bets placed by the players in the game are implemented and optionally collect a fee for providing market making services for the game. In some embodiments, the gambling operator or casino and the third-party market maker(s) share in amounts retained from the losing bets. The third-party market maker(s) may put their capital at risk in accepting the bets of the players in the game, and the gambling operator or casino may utilizes only one or multiple third-party market makers to provide odds and liquidity for the game.

In the embodiments that include the third-party market maker(s), computer systems of the gambling operator or casino and the third-party market maker(s) preferably communicate securely in real-time (e.g., using SSL encryption) to facilitate establishing odds and providing liquidity for the game. In addition, the computer systems of the gambling operator or casino and the third-party market maker(s) are preferably integrated (e.g., via data transfer in XML format) to support reconciliation of the bets placed by the players and accepted by the third-party market maker(s), subsequent payment of winning bets to winning players of the game, retaining of the losing bets by the third-party market maker(s), and fees owed to the gambling operator or casino for conducting the game and the third-party market maker(s) for supporting the game.

In other embodiments of casino games of the present invention, the players bet against the other players in the game, and the winnings paid to the winning players of the games consist of losses from the losing players in the games. This feature eliminates the requirement for the casino to make odds on the games or to define a spread for the games, and more importantly eliminates the requirement for the casino to make odds or to define a spread for the underlying elements of the game, specifically the financial markets. In a pari-mutuel payout format financial gambling game, where the players making winning bets divide the total amount of money bet during the game, the gambling operator utilizes commonly accepted high-speed electronic calculators, known as totalizators or tote boards, to record and display up-to-the-minute odds on the betting action by the players. The payouts at the end of these games are based on the odds calculated by the totalizators on a pari-mutuel basis where the players making winning bets divide the total amount of money bet during the game, minus the fee collected by the gambling operator or casino. Among other things, the present invention allows players within a physical or online casino to gamble in a gaming format that combines both financial investment and casino gaming and betting strategies. For example, in a casino game where the players bet on who can assemble the best performing financial portfolio during a short-term time period, all the player's financial portfolios could lose value, but still the player whose portfolio performed the best, would win the game and the subsequent gambling winnings.

In one embodiment, players are “dealt” or they assemble (based on their own financial strategies) their portfolio from a menu (for basic games simple securities, like just equities would be on the menu, for advanced games, players could choose from a wide array of options, futures, commodities, currencies, etc.). Each player then competes against the other players in the game to generate the best return on their portfolio. The game could have similar elements to other casino games. For example, players could “parlay” or “double down” additional bets, or make an “all-in” wager, as the game proceeded, or place an “insurance” bet analogous to the one included in casino blackjack games. The games could either be for a predefined time frame where, upon ending, players are paid out according to their position, just like a payout at the end of a hand of cards, or there could be a continuous game where each player would be paid out based on how he did vs. the other players from the time he started or “logged into” the game, to the moment he ended or “logged out” of the game. The game could have similar elements to other pari-mutuel gambling games. For example, a player might be able to make various combination bets with multiple financial data points, such as an “exacta” bet, covering the top two data points in order, or a “trifecta” bet, covering the top three data points in order. In addition, a bettor may bet on a series of games, such as a “daily double” bet, where the player attempts to predict the winning financial data points of two consecutive games, a “pick-three” bet, where the player attempts to predict the winning financial data points of three consecutive games, and a “pick-six” bet, where the player attempts to predict the winning financial data points of six consecutive games. In some embodiments, in order to participate in a game, each player must initially convert his/her money into chips issued by the casino, the player then uses the chips for wagering during the game and, when the player exits the game or the game ends, the player converts the chips back into money.

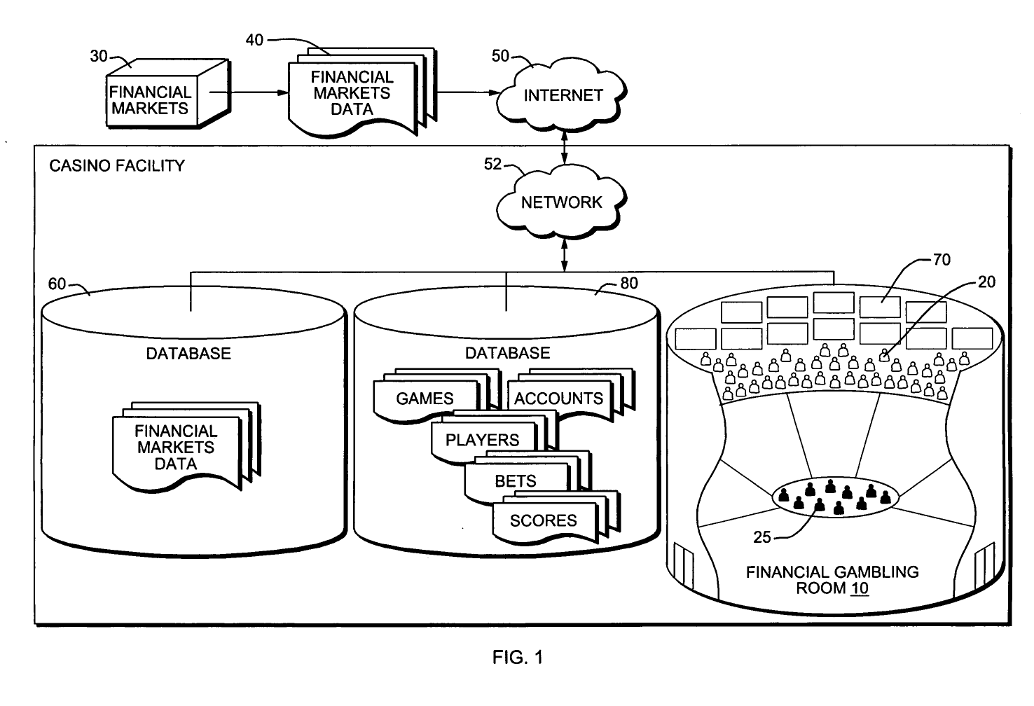

The game could be played online, or in a physical gaming room of a casino. Players online would adjust their positions via the online user-interface using their mouse and keyboards, while casino players could either have a console by which they could play the game, or the casino could even simulate a market trading floor where players would call out or hand signal their positions to casino workers (e.g., workers 25 in FIG. 1) who would make the appropriate adjustments to their portfolio as signaled. The financial gambling game would continuously stream financial market and game data to the players on their respective screens or on large LCD screens in the casino.

FIG. 1 illustrates a forum for conducting a casino game in accordance with the present invention, wherein the players 20 are physically present in a common location (i.e., financial gambling room 10 of a casino) during the game. The gambling operator or casino establishes a set of rules for the game. The rules define one or more players 20 as winners, based on at least one financial market data value that fluctuates based on market activity in a financial market 30 that is distinct from the game. Financial market 30 corresponds, for example, to a government-regulated financial market or an over-the-counter financial market. For purposes of this description, each player 20 corresponds either to a single person or a group of persons that collectively participate in the game as a team.

The gambling operator or casino subscribes to one or more financial market data services, collects financial market information including the at least one financial market data value from the market data services using computerized networks 50, 52, stores the financial market information in database 60, and displays the financial market data and other pertinent game data, to the players 20 on large screens 70 visible to all players 20. In an alternate embodiment, the streaming financial and game data is provided to each of the players on a computer screen of an individual gaming console. The financial data 40 provided to the gambling operator or casino from the third-party data source may comprise streaming financial data such as that provided by Bloomberg or other recognized financial data services. The financial market data value(s) used in the game correspond to a value of a financial market instrument such as a stock, option, future, fund, bond or physical commodity, or a value of an interest rate, index, exchange rate, or data release. Updates to the financial market data value are electronically received from a third-party data source 40 over computer networks 50, 52. Financial gambling room 10 is electronically coupled to the third-party data source 40. During the game, players 20 play and bet against each other in accordance with the established set of rules and the at least one financial market data value. The financial market data value(s) used in the game correspond to a financial market instrument such as a stock, option, future, fund, bond or physical commodity, or an interest rate, index, exchange rate, or data release. The casino collects a fee for conducting the game.

The gambling operator or casino's database 80 stores the gaming history of each player 20 including previous game scores, bets and winnings. As described below, the player's gaming history stored in database 80 is used by the gambling operator or casino to determine eligibility for participation in future games, tiers, or tournaments. Based on information stored in database 80 and criteria established by the gambling operator or casino, the casino may establish one or more gaming tiers or levels for players to compete. A player's ability to compete within a tier or level could be based upon the player's historical bets and winnings. Players move between different tiers or levels as they reach a particular threshold which promotes the player into a higher tier or level, or demotes the player down to a lower tier or level. The gaming tiers or levels may be established to promote or demote players from higher or lower stakes games, or in a tournament format where winning players continue to participate in the tournament, and losing players are eliminated from the tournament. In one embodiment, each gaming tier or level specifies one or more maximum bets that each player may make. Optionally, the stored gaming history for a player may include both past scores and winnings of the player that occurred during participation by the player in an on-line forum where the player was physically separated from other players during the game, and past scores and winnings of the player that occurred during participation by the player in a forum where the player was physically present with other players during the game. The database 80 also optionally maintains an odds book based on bets placed by the players 20 and displays the results to the players on screens 70 prior to commencement of a game. In this embodiment, payouts at the end of the game are based on the pari-mutuel odds calculated by the totalizators.

A variety of fees may be charged by the gambling operator or casino for conducting or hosting the game. For example, the casino may charge an initial fee (or an entry fee) to each player 20 who participates in the game. A fee corresponding to a percentage of amounts wagered by the players 20 during the game can also be collected by the casino. Alternatively, the fee collected by the casino may correspond to a fixed fee associated with each round of the game, or a percentage of winnings.

The casino game of the present invention optionally utilizes a gaming element with an outcome based on chance such as, for example, playing cards, dice, or a wheel. In these embodiments, the outcome of the game is determined in accordance with the at least one financial market data value that fluctuates during the game and an outcome of the gaming element. In one such embodiment the outcome of the game could be based on whether or not a financial data point matches a random number, or series of numbers. Using a slot or similar machine to generate a random number from at least one spinning wheel, a player would win the game if the randomly generated numbers from the machine matched all, or a portion of, a particular financial data point. The outcome of the game may further be determined in accordance with the betting strategy of the winner or other players 20.

In some embodiments of the present invention, the outcome of the game is determined in accordance with an accuracy by which the winner predicts a future value of the at least one financial market data value (e.g., the future value of a stock, bond or interest rate). The outcome of the game may also be fully or partially determined by the amount of money a player has won from other players in the game.

In one embodiment where, for example, each player holds a portfolio of financial instruments, each player assigns varying weights of importance to one or more financial data values or predictions about how each of the financial instruments will perform during the game, and the weights are used to calculate a score for the player. Alternatively, each player may wager varying amounts on each of a plurality of financial data values or predictions.

During the game, the score of each player, the financial data points held by each player, and/or the accuracy of predictions made by each player about how each of the financial instruments held by the player will perform during the game, may be displayed to all other players during the game on screens 70 or individual gaming consoles (not shown). Alternatively, some or all of this information about the position of a player in the game may be maintained in secret from one or more other players during one or more segments of the game, or during all of the game. For example, some or all of this information for a particular player may only be revealed to other players during one or more intermediate segments of the game. In other embodiments, the players might not know the financial data points and/or the accuracy of predictions made by the player, until the very end of the game. Such embodiments provide opportunities where players could implement gambling strategies such as those implemented in poker to bluff other players into believing they held a superior and potentially winning combination of financial data points and/or predictions, when in fact they held an inferior and most likely a losing combination of the same. If the strategy worked, and the other players in the game folded, the player with the inferior and most likely losing combination of financial data point and/or predictions would win the game based on their gambling strategy. In another embodiment, the game rules may be such that a player is eliminated from the game when the score of the player or a financial market data value reaches or falls below a predetermined threshold.

As mentioned above, the rules of the game may provide for the random assignment of financial instruments to each player (e.g., each player is dealt a set of cards by the casino, where each of the cards corresponds to a different financial instrument). In some of these embodiments, the game rules may provide for exchange, during at least one game interval, of one or more financial instruments initially assigned at random to each player for one or more further financial instruments assigned at random to the player. For example, a player may “discard” one of the financial instruments previously “dealt” to the player at which time another financial instrument will be “dealt” to the player. The game rules may also provide for the elimination of financial instruments that are performing poorest at one or more intervals during the game, and players holding eliminated financial instruments are either eliminated from the game, or are permitted to re-pick (or are dealt) one or more financial instruments from remaining financial instruments in the game.

The casino may maintain odds for the game (e.g., odds that each player will win) and may periodically recalculate the odds for each player during the game. In these embodiments, the rules established by the casino may permit each player to adjust their positions or predictions during the game, and a player who selects a correct position or makes a correct prediction will win a varying amount depending upon when the player selected the correct position or made the correct prediction. For example, the winnings of a player who selects a correct position or makes a correct prediction will decrease over time depending on when the player selected the correct position or made the correct prediction.

In some embodiments, players must increase their bets at certain intervals of the game in order to remain in the game, or players must match a bet of at least one other player at certain intervals of the game in order to remain in the game. The rules may also set a minimum wager (e.g., an ante), a maximum wager, or both, for each player in the game. The rules established by the casino may also provide each player with an ability to wager money in order to purchase an option that permits the player to trade-out one financial instrument for another financial instrument held by the player, change a weighting or prediction assigned to a financial instrument, increase a bet, or purchase insurance against an unfavorable outcome.

The rules may be established such that the game ends after a predetermined period of time has elapsed. Alternatively, the game may have an indefinite end time. For example, the casino may pay each player when the player leaves the game or at one or more intermediate points during the game, based on the relative performance of the player compared to the other players in the game, from the time the player joined the game to a later time. In other embodiments, the game ends when a score of a player reaches a predetermined threshold, or when the value of a particular financial instrument or other financial data value reaches a predetermined threshold.

Based on information stored in database 80 and criteria established by the casino, the casino may establish one or more gaming tiers or levels for players to compete. A player's ability to compete within a tier or level could be based upon the player's historical performance or winnings. Players move between different tiers or levels as they reach a particular threshold which promotes the player into a higher tier or level, or demotes the player down to a lower tier or level. The gaming tiers or levels may be established to promote or demote players from higher or lower stakes games, or in a tournament format where winning players continue to participate in the tournament, and losing players are eliminated from the tournament. In one embodiment, each gaming tier or level specifies one or more maximum bets that each player may make.

The game rules may permit players to bet on the relative performance of a common predefined set of financial instruments over a predetermined set of time. In these embodiments, the rules may provide that the winners of the game are those players who made correct predictions and the winnings paid to those players will include losses from the players with the incorrect predictions. In an example of such a game, each player ranks the common set of financial instruments from 1 to X, where X equals the total number of financial instruments in the set, and places a bet that the performance of the financial instruments in the common set during a predetermined period of time will rank in the same order as the rankings made by the player. The rules may also permit each player to place a combined bet on the financial instruments from the common set that will perform best, second best and third best, during a predetermined period of the game or during successive predetermined periods of the game. Such bets would be analogous to “win”, “place” or “show” bets, or exacta or trifecta bets in the case of horse racing. The rules may also permit each player to place a combined bet on the financial instruments from the common set that will perform worst, second worst and third worst, during a predetermined period of the game.

The payouts made by the casino to the players at the end of the game may vary. For example, a first place winner of the game can be paid the total amount of the bets placed during the game by all the players, minus the fee collected by the casino. Alternatively, the first place winner of the game will receive the highest share of the total bets placed during the game by all the players, minus the fee collected by the casino, and some or all of the other participants receive smaller shares of the total bets placed during the game by all the players. In a still further embodiment, each player that made a correct prediction about the performance of a financial instrument wins and all other players lose.

In one embodiment, the game may include a progressive jackpot made, for example, by pooling a small percentage of all money wagered during previous game(s). The progressive jackpot could be triggered by, for example, a player winning a fixed number of games in a row or by an amount that exceeds a certain threshold. The jackpot will continue to grow as more people play until the progressive jackpot is triggered. The progressive jackpot could correspond to a stand alone progressive jackpot, which is linked only to a single game at a casino. Alternatively, the progressive jackpot could correspond to an in-house or proprietary progressive jackpot, where wagers from a group of games linked together and owned and operated by the casino are pooled to create the jackpot. In addition, the progressive jackpot may correspond to a wide area progressive jackpot, where wagers from different games are linked together from many unrelated casinos, and are operated by an independent operator rather than a single gaming company. The casino shares in a percentage of the winnings but the operator owns the progressive jackpot aspect of the game.

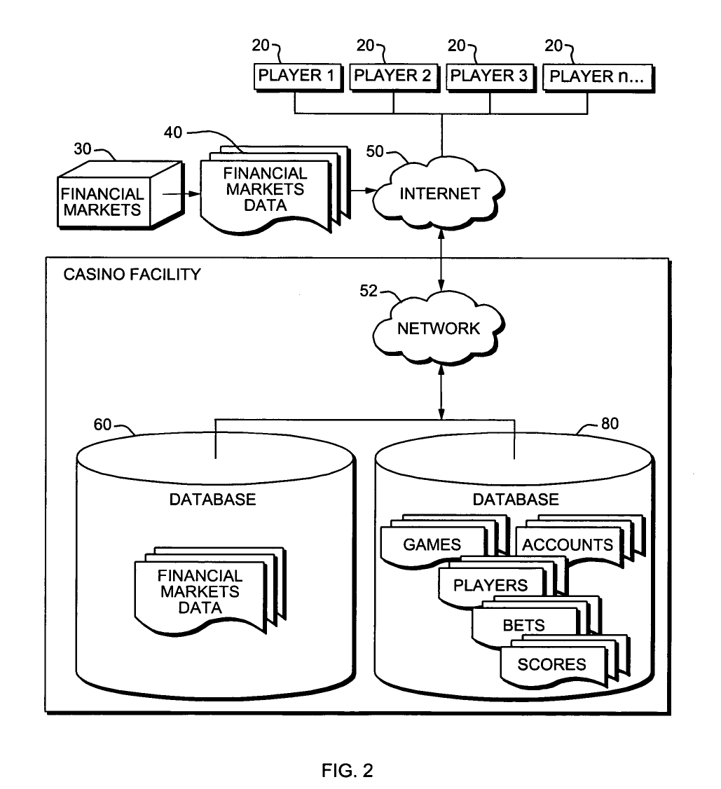

FIG. 2 illustrates an on-line forum for conducting a casino game in accordance with the present invention. In contrast to FIG. 1, in the embodiment of FIG. 2, players 20 are physically separated from each other during the game. Rather than all the players being physically present in the same gambling room, each of the players 20 in this embodiment is connected to the other players and the casino by computer networks 50, 52. In the online embodiment shown, each player 20 creates an account within the online forum for accessing the game over the computer network. During creation of the online account, each player 20 establishes an online payment method for funding bets, such as a credit card, bank draft, electronic check, electronic funds transfer or PayPal® services. Except for the fact that the players are located remotely from each other, the game forum shown in FIG. 2 functions substantially the same as the forum of FIG. 1. It will be understood that various combinations of the game forums shown in FIGS. 1 and 2 are possible, such that some of the players will be physically present in the gambling room 10 while other players will be connected to the gambling room 10 remotely over computer networks 50, 52.

Considering the breadth of gambling games, financial data points and investment strategies, there are numerous games that could be created from the combination of gambling games and financial instruments. All such combinations are considered to be within the scope of the present invention. For purposes of illustration, several specific examples of games in accordance with the present invention are set forth below, including games of chance, games of skill, and combinations thereof. For purposes of the examples below, “Game of Chance” shall mean a game predominately determined by chance where a player pays valuable consideration for the opportunity to win a prize of greater value; and “Game of Skill” shall mean a game between two or more participants where the winner is determined predominately by the skill of the participants.

### EXAMPLE NO. 1

### “Wall Street Match 4” Game (Game of Chance)

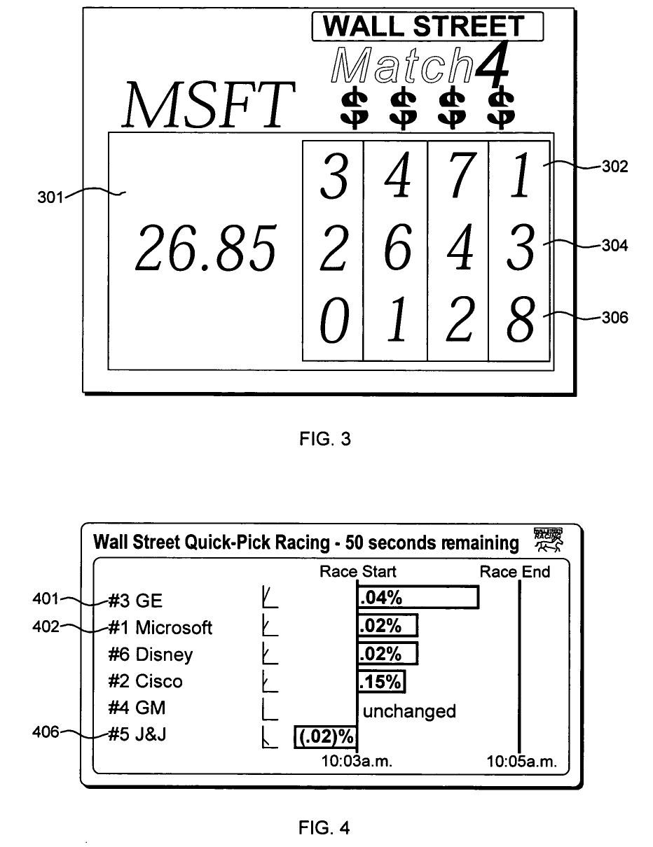

This game combines the sophistication of Wall Street with the excitement and simplicity of slot machines to create an ideal game for the Wall Street and slot enthusiast. An exemplary screen shot illustrating the implementation of this game is shown in FIG. 3. The “Wall Street Match 4” game may be implemented on, for example, a physical slot machine in a casino, or a virtual slot machine implemented as part of an on-line game. When a virtual slot machine is used, the player may, for example, use a remote client computer coupled over a computer network to a server for playing the game. In the case of a virtual slot machine implemented with a remote client computer in communication with a server, the functionality used to implement the slot machine may be split between the client computer and the server, or implemented entirely on one of such devices.

In one embodiment of the “Wall Street Match 4” game, the current value 301 of a security (e.g., Microsoft stock in the example shown), market index, economic or financial market indicator, foreign exchange rate, physical commodity or interest rate, is displayed on a screen on the slot machine. The current value 301 is provided to the display screen via live financial market data that is streamed to the machine used for implementing the game. The player deposits his/her bet in the slot machine, and then “spins” the machine. In response to the “spin,” a random number generator in the machine generates numbers that are shown in rows 302, 304, 306. During the “spin,” the randomly generated numbers scroll past the player. In one embodiment, the machine pays the player a jackpot if at least one of the random digits shown on at least one row 302, 304, 306 matches a digit representing the current value 301 of the security, market index, economic or financial market indicator, foreign exchange rate, physical commodity or interest rate, when the digits on the display stop spinning, otherwise, the machine retains the wager. Alternatively, the machine pays the player a jackpot if at least one of the random digits shown on a specific one or ones of the rows 302, 304, 306 matches a digit representing the current value 301 of the security, market index, economic or financial market indicator, foreign exchange rate, physical commodity or interest rate when the digits on the display stop spinning, otherwise, the machine retains the wager. In other embodiments, in order for there to be a payout, there must be positional correspondence between at least one of the random digits shown on at least one row 302, 304, 306 and a digit representing the current value 301 of the security, market index, economic or financial market indicator, foreign exchange rate, physical commodity or interest rate when the digits on the display stop spinning (e.g., the left-most digit in the current value 301 must match a digit in the left-most column of rows 302, 304, 306, etc.). In still further embodiments, the payout may be progressively higher as more digits are matched. For example, a higher payout may occur if, at the end of the spin, all the numbers in one or more of the rows 302, 304, 306 of the slot machine exactly match the current value 301. Like traditional slot machines, the machine used for implementing the “Wall Street Match 4” game will be programmed to provide the house with a slight advantage.

In one specific embodiment of the “Wall Street Match 4” game, the slot machine (or a computer coupled thereto) randomly selects a stock with a price ranging from $10.00 to $99.00. If the random number generator in the slot machine generates the exact same numbers on one or more of rows 302, 304, 206, the player wins. This game could be implemented in other denominations, in order to match player preferences. Using the game controls, players can “spin again” on the same security, market index, economic or financial market indicator, foreign exchange rate, physical commodity or interest rate, or spin again with a new randomly selected security, market index, economic or financial market indicator, foreign exchange rate, physical commodity or interest rate. In addition, a “Match 5” version of the game could be implemented on stocks and commodities prices at more than $100.00, or a market index, economic or financial market indicator, or foreign exchange rate that is more than five digits.

A progressive jackpot could also be implemented with the “Wall Street Match 4” game. In cases where a progressive jackpot is used, higher bets from players may increase the likelihood of winning the progressive jackpot, thus encouraging higher wagers from players.

### EXAMPLE NO. 2

### “Wall Street Racing” Game (Game of Chance)

This game provides an easy way for players to participate in the excitement of Wall Street based games. A machine used for implementing the game randomly picks securities, market indices, economic or financial market indicators, foreign exchange rates, physical commodities or interest rates, to participate in a race, and picks a security, market index, economic or financial market indicator, foreign exchange rate, physical commodity or interest rate for each player betting on the race. For example, the machine used for implementing the “Wall Street Racing” Game will randomly pick six stocks to participate in a race. The machine will also randomly assign one of the six stocks to each player betting on the race. In addition, just like at a track, players are given the option to place combinations of bets including exactas, trifectas, daily double, pick three and pick six. The machine used for implementing the “Wall Street Racing” game will be programmed to provide the house with a slight advantage.

A screen shot illustrating an exemplary implementation of this game is shown in FIG. 4. The “Wall Street Racing” Game may be implemented on, for example, a physical machine in a casino, or a virtual machine implemented as part of an on-line game. When a virtual machine is used, each player may, for example, use a remote client computer coupled over a computer network to a central server for playing the game. In the case of a virtual machine implemented with remote client computers in communication with a server, the functionality used to implement the machine may be split between the client computers and the server.

In the specific embodiment of the “Wall Street Racing” Game shown in FIG. 4, the machine randomly selects six stocks (401-406) in a race lasting a predetermined amount of time (e.g., 2 minutes in the example shown). The six stocks 401-406 are shown on a display coupled to the machine, as shown in FIG. 4. Greater than or fewer than six stocks could alternatively be used, and other types of securities, market indices, economic or financial market indicators, foreign exchange rates, physical commodities or interest rates could be used instead of stocks. In the example, shown, the machine randomly selects one of the six stocks for each player betting on the race. The current price of each of the six stocks 401-406 is provided via live financial market data that is streamed to the machine used for implementing the game. The stock that increases in value the most on a percentage basis during the period of the race (e.g., 2 minutes in the example shown) wins the game. Bets are settled at the end of the race, and player(s) holding the winning stock are paid.

In some embodiments of this game, the race could be setup to last as long as an entire trading day, or short-term versions could last just 1 or 2 minutes. The house could assign “win” bets or “lose” bets to the players. “Win” bets would be for a security, market index, economic or financial market indicator, foreign exchange rate, physical commodity or interest rate, to go up the most (either in percentage or gross amount) during the race, and “lose” bets would be for a security, market index, economic or financial market indicator, foreign exchange rate, physical commodity or interest rate, to go down the most during the race. In such versions, the machine used for implementing the game would automatically pick one of the six securities, market indices, economic or financial market indicators, foreign exchange rates, physical commodities or interest rates, for each player betting on the race, and whether that security, market index, economic or financial market indicator, foreign exchange rate, physical commodity or interest rate, had to win or lose the race. In some versions of the game, players could have the option of surrendering their bet, or raising their bet at various predetermined points during the game. Functionality on the machine used for implementing the game could also permit players to select Win, Place or Show bets for their security, market index, economic or financial market indicator, foreign exchange rate, physical commodity or interest rate.

### EXAMPLE NO. 3

### “Wall Street Rangers” Game (Game of Skill)

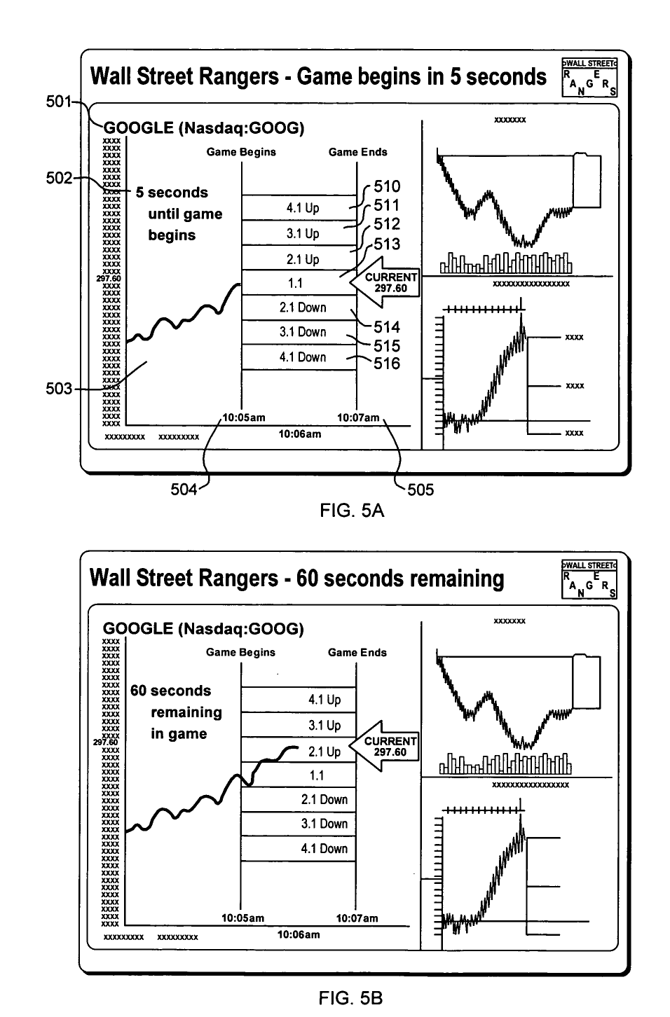

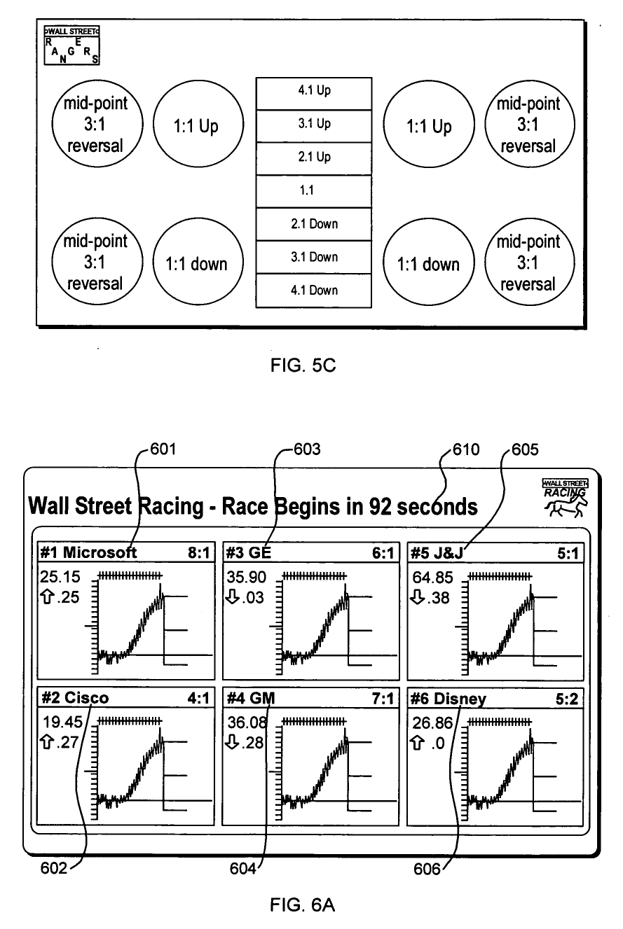

This game offers an instant and exciting way for players to bet on Wall Street movements. Players simply place their bets on the range of values they believe a security, market index, economic or financial market indicator, foreign exchange rate, physical commodity or interest rate, will be within at the end of a given period of time. In one embodiment, the game pays fixed odds for each range of values. Screen shots illustrating an exemplary implementation of this game are shown in FIGS. 5A-5C. The “Wall Street Rangers” game may be implemented on, for example, a physical machine in a casino, or a virtual machine implemented as part of an on-line game. When a virtual machine is used, each player may, for example, use a remote client computer coupled over a computer network to a server for playing the game. In the case of a virtual machine implemented with one or more remote client computers in communication with a server, the functionality used to implement the machine may be split between the client computer(s) and the server.

In the specific embodiment of the “Wall Street Rangers” game shown in FIGS. 5A-5C, a machine used for implementing the game displays a security 501 (e.g., Google stock in the example shown) (or a market index, economic or financial market indicator, foreign exchange rate, physical commodity or interest rate), a few minutes before the game and then starts a countdown 502 to the beginning of the game (shown as preset start time 504). The security 501 may be selected by the player from a fixed universe of possibilities, or pre-selected by the machine or gaming sponsor. During the countdown period (shown specifically in FIG. 5A), a graph 503 illustrating the value of the security 501 during the countdown period is shown on the display. Live financial data is streamed to the machine and used to generate the graph 503, and track the current price of security 501 during the game (see FIG. 5B). The machine also sets an end time (505) for the game, which is also shown on the display.

The security, market index, economic or financial market indicator, foreign exchange rate, physical commodity or interest rate, used during the game, the duration of the game, the available betting ranges (510-516) and the odds shown for each betting range, may be established by the house or a third-party market maker. Odds paid are slightly discounted to the actual odds. The odds shown on the display are controlled by the house or a third-party market maker during the countdown period by adjusting the ranges/odds as the real-time market data (shown in graph 503) moves. Bets are settled at the end of the game in accordance with the fixed odds shown for each range.

Referring still to FIG. 5A, during the countdown period, and up until the preset start time 504, players select and bet on one or more ranges of values 510-516 that they believe the security 501 (or a market index, economic or financial market indicator, foreign exchange rate, physical commodity or interest rate), will be within at the end time 505. Players may bet on more than one range. For example, if a player bets on ranges 510 and 511, and range 511 wins the game, the payer would be paid 3:1 on their range 511 bet, and lose their range 510 bet. The machine used for implementing the game may randomly select the security 501 (or a market index, economic or financial market indicator, foreign exchange rate, physical commodity or interest rate), a few minutes before the game. In some embodiments, the duration of each game (from start time (504) to end time (505)) will be from 1-5 minutes; other durations may alternatively be used. As shown in FIG. 5C, in some embodiments of the game, players may be given an option to surrender their bet or double-down half-way through the game.

### EXAMPLE NO. 4

### “Wall Street Rangers” Game (Game of Chance)

This game is substantially the same as the game described in Example 3 above, except (i) the security, market index, economic or financial market indicator, foreign exchange rate, physical commodity or interest rate, and (ii) the selected value range are randomly selected by the machine or a gambling operator or casino.

### EXAMPLE NO. 5

### “Wall Street Racing” Game (Game of Skill)

This game is similar to the game described above as Example 2, except in this game each player selects the security, market index, economic or financial market indicator, foreign exchange rate, physical commodity or interest rate to bet on (rather than having the security, market index, economic or financial market indicator, foreign exchange rate, physical commodity or interest rate randomly assigned to the player). Just like at a track, players are given the option to place combinations of bets including exactas, trifectas, daily double, pick three and pick six. Players may also be given the chance to bet on both winners and losers of the race. The machine used for implementing the game will be programmed to provide the house with a slight advantage.

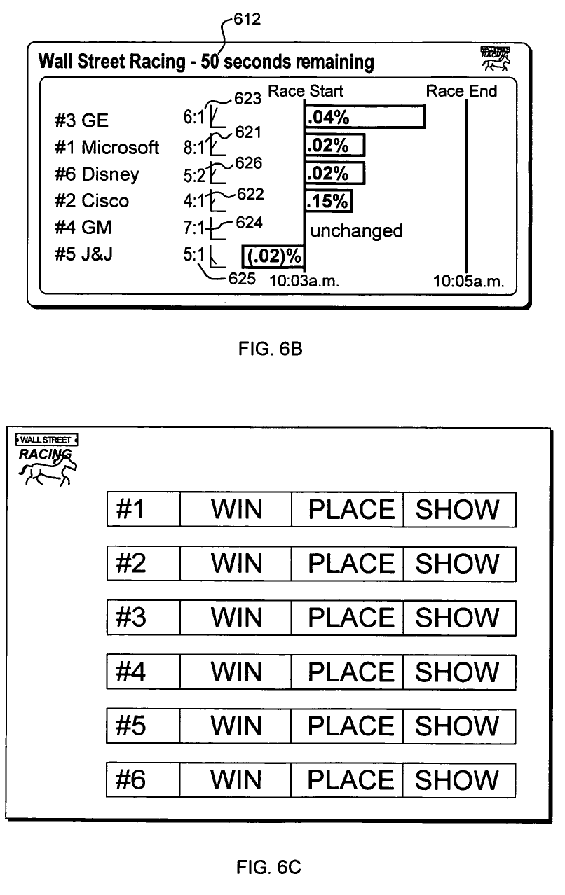

Screen shots illustrating an exemplary implementation of this game are shown in FIGS. 6A-6C. The “Wall Street Racing” game of skill may be implemented on, for example, a physical machine in a casino, or a virtual machine implemented as part of an on-line game. When a virtual machine is used, each player may, for example, use a remote client computer coupled over a computer network to a central server for playing the game. In the case of a virtual machine implemented with remote client computers in communication with a server, the functionality used to implement the machine may be split between the client computers and the server.

In the specific embodiment of the “Wall Street Racing” game shown in FIGS. 6A-6C, a machine used for implementing the game displays six securities 601-606 (or market indices, economic or financial market indicators, foreign exchange rates, physical commodities or interest rates) a few minutes before the game and then starts a countdown 610 to the beginning of the game. (Greater than or fewer than six securities, market indices, economic or financial market indicators, foreign exchange rates, physical commodities or interest rates could alternatively be used.) During the countdown period (shown specifically in FIG. 6A), graphs illustrating the value of each security 601-606 (or market index, economic or financial market indicator, foreign exchange rate, physical commodity or interest rate) during the countdown period are shown on the display. Live financial data is streamed to the machine and used to generate the graphs, and track the current value of the securities 601-606 (or market indices, economic or financial market indicators, foreign exchange rates, physical commodities or interest rates) during the game. In addition, the players can use the current financial data displayed on the graphs to formulate their security/market index/economic or financial market indicator/foreign exchange rate/physical commodity/interest rate selection and betting strategy. As shown in FIG. 6B, during the duration of the game, the machine displays a timer 612 showing time remaining until the end time for the game.

The securities 601-606 (or market indices, economic or financial market indicators, foreign exchange rates, physical commodities or interest rates) used during the game, the duration of the game and the odds (621-626) shown for each security, market index, economic or financial market indicator, foreign exchange rate, physical commodity or interest rate, may be established by the house or a third-party market maker. Odds paid are slightly discounted to the actual odds. The odds shown on the display are controlled by the house or a third-party market maker during the countdown period by adjusting the ranges/odds as the real-time market data (shown in the graphs on FIG. 6A) moves. Bets are settled at the end of the game in accordance with the odds shown for each security, market index, economic or financial market indicator, foreign exchange rate, physical commodity or interest rate.

Referring still to FIG. 6A, during the countdown period, and up until the preset start time, players bet on the security, market index, economic or financial market indicator, foreign exchange rate, physical commodity or interest rate that will win, place and or show (using, for example, the interface shown in FIG. 6C). During the race (as shown in FIG. 6B), the percentage increase or decrease (relative to the start time) of each of the six stocks 601-606 is calculated via the live financial market data that is streamed to the machine, and shown to the players. The security, market index, economic or financial market indicator, foreign exchange rate, physical commodity or interest rate that increases in value the most on a percentage basis during the period of the race (e.g., 2 minutes in the example shown) wins the game. In some embodiments of this game, the race could be setup to last as long as an entire trading day, or short-term versions could last just 1 or 2 minutes.

### EXAMPLE NO. 6

### “Wall Street 2-Cards” Game (Game of Skill or Chance)

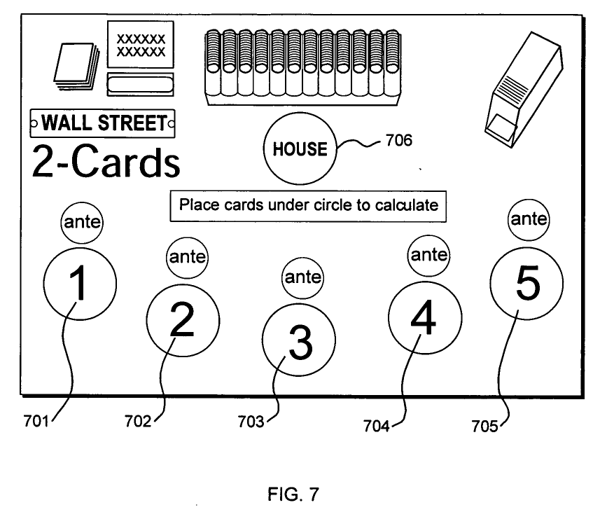

This game invites players to match their Wall Street wits against the house. FIG. 7 illustrates an exemplary table layout of the “Wall Street 2-Cards” game, in accordance with the present invention. The exemplary table layout includes five player locations 701-705. A dealer from the house is positioned at table location 706. A deck of playing cards is provided. Each card in the deck includes a stock symbol on one side of the card corresponding to one of a defined list of possible securities, market indices, economic or financial market indicators, foreign exchange rates, physical commodities or interest rates.

As with poker, each player will first ante into the game. The dealer deals all players, as well as the house, two cards. Thus, each player and the house are assigned two random securities, market indices, economic or financial market indicators, foreign exchange rates, physical commodities or interest rates, from a defined list of possibilities. The player's cards are dealt “face down,” such that players can see their own securities, market indices, economic or financial market indicators, foreign exchange rates, physical commodities or interest rates, but not the securities, market indices, economic or financial market indicators, foreign exchange rates, physical commodities or interest rates of the other players. One card dealt to the house is dealt “face-up” (such that all player's can see the security, market index, economic or financial market indicator, foreign exchange rate, physical commodity or interest rate) and the other card dealt to the house is dealt “face down.” In cases where the game is implemented in a physical casino, RFID technology embedded in the cards is used in combination with sensors proximate the table to display relevant portfolio information to each player. After the cards are initially dealt, each player places a bet that the two securities, market indices, economic or financial market indicators, foreign exchange rates, physical commodities or interest rates dealt to the player will be beat the house in a portfolio race that begins at a predetermined time. The portfolio race is similar to the races described in Examples 2 and 5 above, however, in this game the portfolio of each player is “racing” against the portfolio dealt to the house. Similar to poker, players will have the option of folding or raising their bets at various points during the game. In one embodiment, the house edge is derived from capturing the ante and bets from players who fold during the hand.

In one embodiment of the “Wall Street 2-Cards” game, all players must ante in each round, and the house “deals” or assigns to each player, as well as the house, two blue-chip stocks. Each player can see only his/her stocks (or other securities, market indices, economic or financial market indicators, foreign exchange rates, physical commodities or interest rates) and one stock (or or other security, market index, economic or financial market indicator, foreign exchange rate, physical commodity or interest rate) of the house. Live financial market data is streamed to one or more displays associated with the game. The players are only playing their portfolio against the house, and players will fold or bet into the game before the “race” begins. At various points during the game, players will be allowed to either fold, and lose only what they bet so far, or raise their bets against the house similar to surrendering and doubling-down in black-jack. The initial bet, and all additional bets, will be limited to a multiple of the amount of each player's ante at the beginning of the game. Each “race” will last a predetermined amount of time, after which the portfolio of any remaining player that increased by a greater percentage basis than the house will win.

In other versions of the game, player could place a second side bet against other players in the game. In a still further version, both of the house's stocks would be dealt up for the players to view, implying a greater basis of skill for this version of the game.

### EXAMPLE NO. 7

### “Bull Run” Game (Game of Skill)

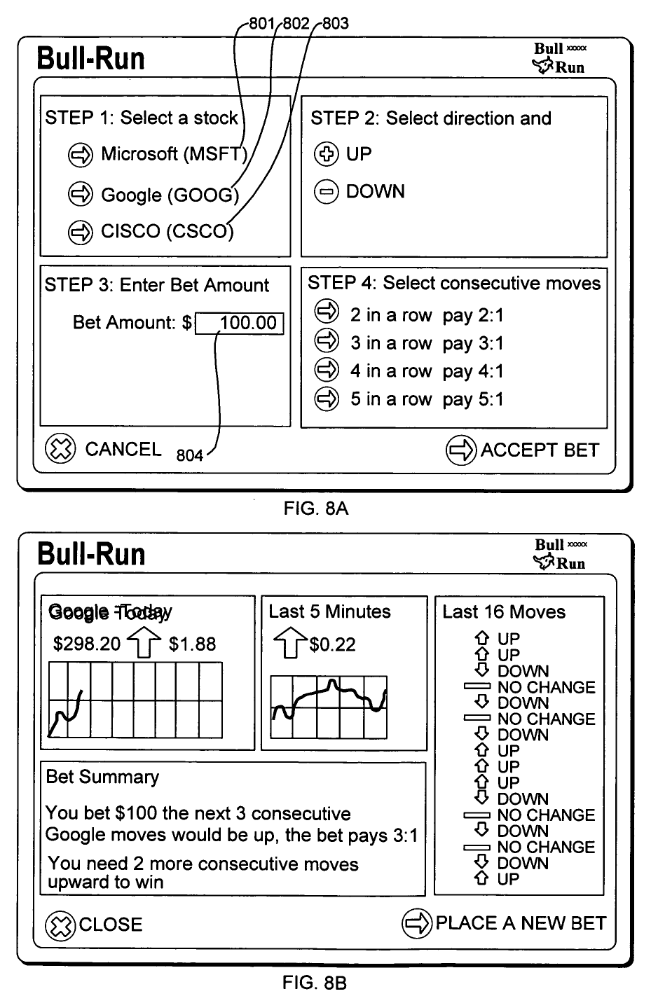

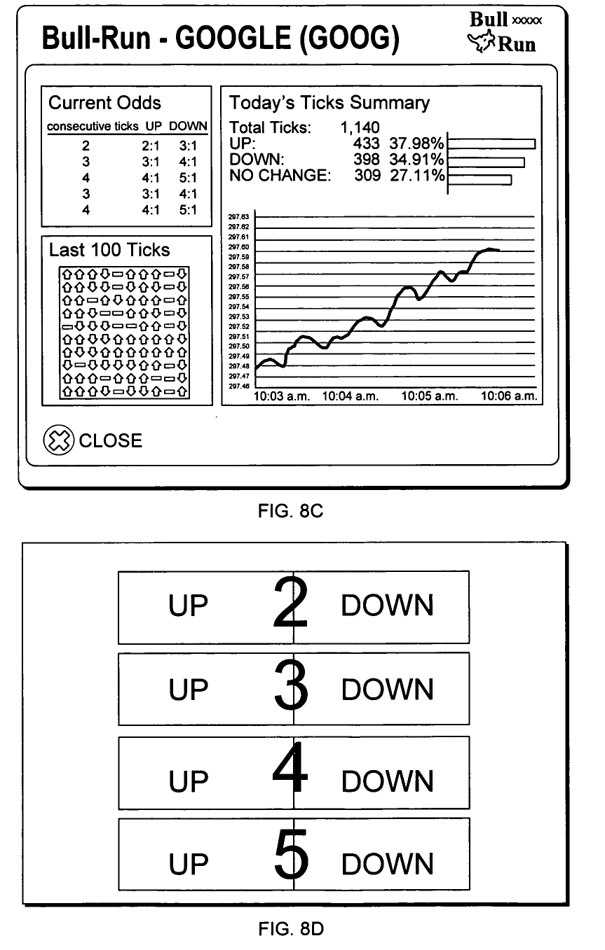

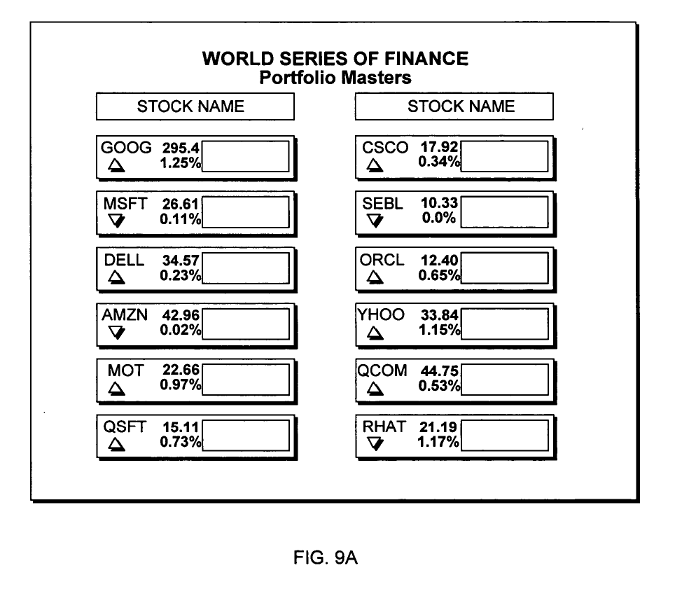

This game offers an instant and exciting way for players to bet on Wall Street movements. In this game, players simply wager that a security, market index, economic or financial market indicator, foreign exchange rate, physical commodity or interest rate will make a “run” in one direction of another. A run is defined as a consecutive number of predefined time segments in which the value of the security, market index, economic or financial market indicator, foreign exchange rate, physical commodity or interest rate moves in a given direction. Again, the “Bull Run” game may be implemented on, for example, a physical table (as shown in FIG. 8D) in a casino, or a virtual table (FIG. 8D could alternatively correspond to a virtual table layout) implemented as part of an on-line game. When a virtual table is used, each player may, for example, use a remote client computer coupled over a computer network to a server for playing the game. In the case of a virtual table implemented with one or more remote client computers in communication with a server, the functionality used to implement the table may be split between the client computer(s) and the server.

In the specific embodiment of the “Bull Run” game shown in FIGS. 8A-8D, a machine used for implementing the game monitors live financial data streamed to the machine, and the value of a selected security, market index, economic or financial market indicator, foreign exchange rate, physical commodity or interest rate is reported to the player in regular intervals (e.g., every 5 seconds). The player bets on how many times in a row a given security, market index, economic or financial market indicator, foreign exchange rate, physical commodity or interest rate will move in a given direction (i.e., either up or down). The game may run on a continuous basis such that players can jump into the action whenever they sense a run by a security, market index, economic or financial market indicator, foreign exchange rate, physical commodity or interest rate. Referring now to FIG. 8A, in the live rolling game, players can place a bet at any time on any of the available stocks 801-803 (or other securities, market indices, economic or financial market indicators, foreign exchange rates, physical commodities or interest rates) by selecting the security, market index, economic or financial market indicator, foreign exchange rate, physical commodity or interest rate (Step 1), selecting a direction for the run (Step 2), entering a wager amount in window 804 (Step 3) and selecting a number of consecutive value moves in the selected direction (Step 4). Referring now to FIG. 8B, as live financial market data is continuously streamed to the game and displayed on the machine during the game, positions of players are updated and/or closed out after each predefined time segment of the game (e.g., every 5 seconds.) As shown in FIG. 8A, different odds are applied depending on the number of consecutive value moves selected. The odds are dynamically created by the house, or with the support of a third-party market maker, and posted on the screen shown in FIG. 8A on a continuous basis. Odds paid are slightly discounted to the actual odds.

In this game, bets can be simple, such as a bet on one stock or commodity moving up three times in a row. Alternatively, players can place advanced racing bets by parlaying multiple data points into a bet, e.g., betting three different stocks will all move up 3 times in a row.

### EXAMPLE NO. 8

### “Bull Run” Game (Game of Chance)

This game is substantially the same as the game described in Example 7 above, except (i) the security, market index, economic or financial market indicator, foreign exchange rate, physical commodity or interest rate, (ii) the selected price direction, and (iii) the number of consecutive periods are selected at random for each player by a machine provided by a gambling operator or casino.

### EXAMPLE NO. 9

### “Pick 'em” Game (Game of Skill)

In one embodiment, the “Pick 'em” game is implemented through periodic, tournament-style action where sophisticated traders and gamers compete head-to-head against each other. In these implementations, a player only has to be the best at the table to win. The table can correspond to a physical table at a casino, a virtual table implemented on line using a plurality of remote player computers coupled to a central server over a global computer network, or any other suitable forum provided by a gaming sponsor. The implementations optionally preserve the look and feel of poker action including antes, increasing bets, folding hands, bluffing and scooping the pot.

In the “Pick 'em” game, each player uses his/her charting and investment skill to predict privately what the closing value of a given security, market index, economic or financial market indicator, foreign exchange rate, physical commodity or interest rate will be at the end of a round. A round runs for a set period of time (e.g., 2-5 minutes.) After the players make their private predictions, and during the round, players can increase their bets (bets are made into the pot) or fold. The player whose price prediction is closest to the actual closing value at the end of the round wins the pot. Alternatively, the last player in the round will win the pot if all others have folded. In an alternate implementation, players whose price predictions are the second and third closest to the actual closing value receive lesser amounts from the pot. In a still further variant of this game, a player can buy the right to make a small change to his/her prediction by adding a certain amount to the pot.

### EXAMPLE NO. 10

### “Three Card Draw” Game (Game of Skill)

This game is implemented using cards and a table substantially the same as that described above in connection with the “Wall Street 2-Cards” game. In one embodiment, the “Three Card Draw” game is implemented through periodic, tournament-style action where sophisticated traders and gamers compete head-to-head against each other. In these implementations, a player only has to be the best at the table to win. Again, the table can correspond to a physical table at a casino, a virtual table implemented on line using a plurality of remote player computers coupled to a central server over a global computer network, or any other suitable forum provided by a gaming sponsor or gambling operator. The implementations optionally preserve the look and feel of poker action including antes, increasing bets, folding hands, bluffing and scooping the pot.

In one embodiment of the “Three Card Draw” game, the house assigns a set number of securities, market indices, economic or financial market indicators, foreign exchange rates, physical commodities or interest rates (e.g., three or four) to each player by dealing cards (such as those described above in connection with the “Wall Street 2-Card” game) to each player. Each hand lasts for a defined period of time, and the deals are random. Some of the cards are dealt face-up, other cards are dealt face-down. In some variants, it is possible for a player to draw or turn in certain cards at specified times during hand, or to “Go Low”, i.e., bet that the player's portfolio will have the lowest performance when compared to the portfolios of all other players in the game. A processor/monitor will automatically calculate and display in real time the aggregate performance of the portfolio held by the player during the round, for the player's private viewing. The monitors will show publicly the aggregate performance of each player's “face-up” stocks. The player with the best aggregate performance will win the pot, or if all other players have folded, the last player in the hand will win the pot. Each player will have multiple opportunities during the hand to increase his bet at set times (bets are made into the pot), or fold.

### EXAMPLE NO. 11

### “Portfolio” Game (Game of Skill)

This game is implemented using cards and a table substantially the same as that described above in connection with the “Wall Street 2-Cards” and “Three Card Draw” games. In one embodiment, the “Portfolio” game is implemented through periodic, tournament-style action where sophisticated traders and gamers compete head-to-head against each other. In these implementations, a player only has to be the best at the table to win. Again, the table can correspond to a physical table at a casino, a virtual table implemented on line using a plurality of remote player computers coupled to a central server over a global computer network, or any other suitable forum provided by a gaming sponsor. Some implementations optionally preserve the look and feel of poker action including antes, increasing bets, folding hands, bluffing and scooping the pot. In other implementations, each player stakes an initial equal wager, picks their portfolio, and winner(s) are automatically credited with the proceeds at the end of the round.

The “Portfolio” game is similar to the “Three Card Draw” game described above, except, rather than being dealt securities, market indices, economic or financial market indicators, foreign exchange rates, physical commodities or interest rates, each player selects his/her portfolio (using the player's skill) from a fixed universe of securities, market indices, economic or financial market indicators, foreign exchange rates, physical commodities or interest rates (e.g., the NASDAQ 100). In one embodiment, some picks of each player are made known to other players, while other picks remain private. In a further variant, similar to “Texas Hold 'em, players may share a common set of randomly assigned cards that are dealt “face-up”, and select others that remain private. As in the “Three Card Draw Game,” a processor/monitor will automatically calculate and display in real time the aggregate performance of the portfolio held by the player during the round, for the player's private viewing. The monitors will show publicly the aggregate performance of each player's “face-up” stocks. The player with the best aggregate performance will win the pot, or if all other players have folded, the last player in the hand will win the pot. Each player will have multiple opportunities during the hand to increase his bet at set times (bets are made into the pot), or fold. In other implementations, each player stakes an initial equal wager, picks their portfolio, and winner(s) are automatically credited with the proceeds at the end of the round.

In a specific tournament-style embodiment of the “Portfolio” game, there are 5 or 6 seats to a table, and each player will have an initial ante at the table minimum. Multiple tables are provided. Wagering is pari-mutuel, and the house earns a rake from each round played at the table. The length of each game is approximately 3 minutes from beginning to end. All players at each table are concurrently playing at the same time, not one at a time. This maintains fast action and exciting maneuvering opportunities.

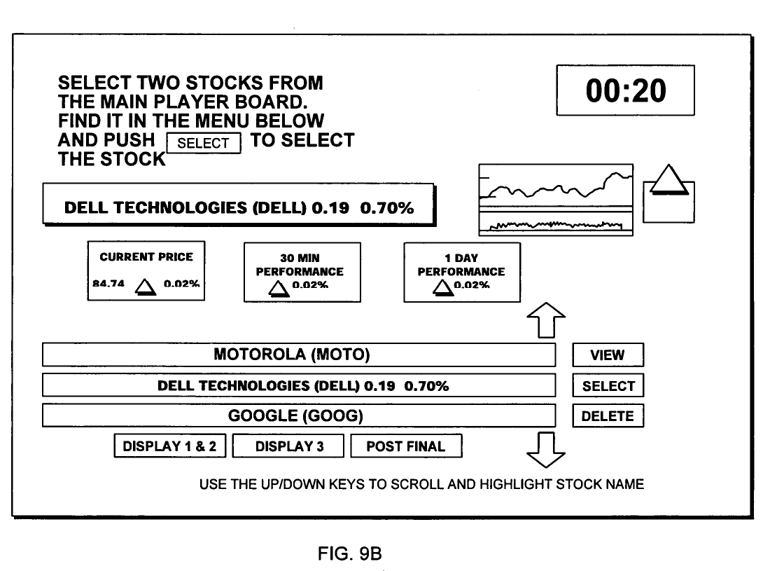

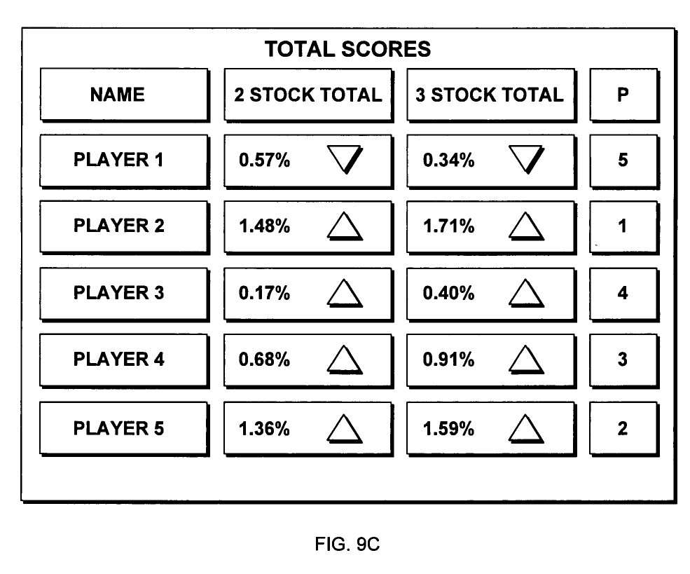

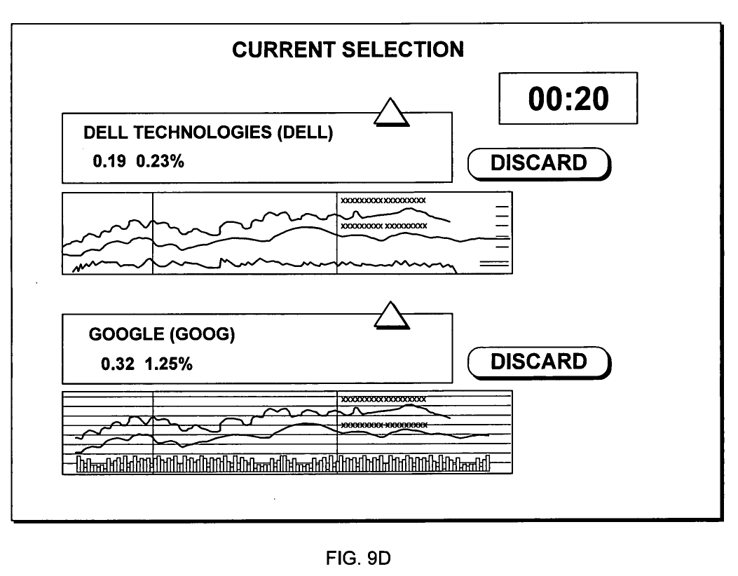

Referring still to the specific tournament-style embodiment of the “Portfolio” game, each segment of the game has a time limit. A timer is displayed on a main game display (shown in FIG. 9A) in front of the players and on a personal 12×12 display (Shown in FIG. 9B) in front of them. There are 4 opportunities to wager in each game: the ante, once after the initial two securities, market indices, economic or financial market indicators, foreign exchange rates, physical commodities or interest rates are evaluated, selected then displayed (which are then posted on the left side main display), after the third security, market index, economic or financial market indicator, foreign exchange rate, physical commodity or interest rate is selected by each player (hidden, not showed to others yet), and then once the 3^{rd} selection is displayed visually on the right side main game display, then a chance for raising is encouraged.

The actual step-by-step play of the specific tournament-style embodiment of the “Portfolio” game is as follows:

1. Each player antes and the table host activates timer. The initial timer is set for 60 seconds. The action begins.

2. Each player presses their game start button and begins evaluating the securities, market indices, economic or financial market indicators, foreign exchange rates, physical commodities or interest rates using live market data from Wall Street on their personal displays. Each player must have evaluated, analyzed and selected two securities, market indices, economic or financial market indicators, foreign exchange rates, physical commodities or interest rates by the end of the 60 second timer and pressed the display button (shown in FIG. 9B) for the two selections to be posted on the left side main game display. FIG. 9C shows the main game display illustrating each player's initial two-stock combined totals at this point in the game.

3. The host then instructs the players that they have 15 seconds to place their wagers based on all players initial stock portfolio. At the end of 15 second wager window, the players then have another 45 seconds to select two more securities, market indices, economic or financial market indicators, foreign exchange rates, physical commodities or interest rates which will be initially hidden from the other players. FIG. 9D illustrates an additional personal game display showing a player's third and fourth stock selection, that is initially hidden from the other players.

4. At the end of 45 seconds each player will discard one of the two hidden selections on their personal display (using the buttons shown in FIG. 9D) and have 15 seconds to place a wager based on the hidden security, market index, economic or financial market indicator, foreign exchange rate, physical commodity or interest rate they have selected. The goal is to have the 3 item portfolio outperform the competitive players 3 item portfolio. Once that wager has been completed, the host posts the hidden selections and opens a 15 second opportunity for players to raise their wagers. Once that wager is done, the host then activates the final game timer for the last 30 seconds of the game. During that last 30 seconds the hidden selection and the first two selections are combined and the real time market results of each players portfolio is calculated in real time from the live market data and displayed on the main game display (shown in FIG. 9C) to the finish.

5. The winner is the remaining player who has combined a 3 item portfolio that outperforms the competitors at the table for the highest percentage gains. The winner takes the pot and a new game begins.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. A method used for conducting a game by a gambling operator or casino in which a plurality of players bet, comprising:
establishing a set of rules for the game, wherein the rules define at least one winner based on at least one financial market data value that fluctuates based on market activity in a financial market that is distinct from the game;
electronically receiving updates to the financial market data value from a third-party data source;
providing a forum, electronically coupled to the third-party data source, where the players play the game and bet against a house, in accordance with the established set of rules and the at least one financial market data value;
wherein the forum is electronically coupled to one or more third-party market makers who establish odds for the game and provide liquidity for bets of all players; and
wherein the one or more third-party market makers payout winning bets to one or more winning players based on the established odds, and retain losing bets of one or more losing players.

2. The method of claim 1, wherein the one or more third-party market makers collect a fee for providing market making services for the game.

3. The method of claim 1, wherein the gambling operator or casino and the one or more third-party market makers share in amounts retained from the losing bets.

4. The method of claim 1, wherein computer systems of the gambling operator or casino and the one or more third-party market makers securely communicate in real-time to facilitate establishing odds and providing liquidity for the game.

5. The method of claim 1, wherein the one or more third-party market makers provide liquidity by ensuring that all bets placed by the players in the game are implemented.

6. The method of claim 1, wherein the one or more third-party market makers put their capital at risk in accepting the bets of the players in the game.

7. The method of claim 1, wherein the gambling operator or casino utilizes only one third-party market maker to provide odds and liquidity for the game.

8. The method of claim 1, wherein the gambling operator or casino utilizes multiple third-party market makers to provide odds and liquidity for the game.

9. The method of claim 1, wherein computer systems of the gambling operator or casino and the one or more third-party market makers are integrated to support reconciliation of the bets placed by the players and accepted by the one or more third-party market makers, subsequent payment of winning bets to winning players of the game, retaining of the losing bets by the one or more third-party market makers, and fees owed to the gambling operator or casino for conducting the game and the one or more third-party market makers for supporting the game.

10. The method of claim 9, wherein the computer systems of the gambling operator or casino and one or more third-party market makers supporting the game are integrated via data transfer in XML format.

11. The method of claim 4, wherein the secure connection uses SSL encryption.

12. An apparatus for conducting a game by a gambling operator or casino, comprising:
a machine that accepts a wager from a player;
a port in the machine that receives live financial market data;
a display coupled to the machine that shows the current value of a security, market index, economic or financial market indicator, foreign exchange rate, physical commodity or interest rate, wherein the current value includes at least four digits, and the current value is provided to the display using the live financial market data provided via the port;
a random number generator that generates at least four random digits that are shown on a row of the display when digits on the display spin;
wherein the machine pays the player a jackpot if at least one of the random digits shown on the the row matches one of the digits representing the current value of the security, market index, economic or financial market indicator, foreign exchange rate, physical commodity or interest rate, when the digits on the display stop spinning.

13. The apparatus of claim 12, wherein the slot machine randomly selects the security, market index, economic or financial market indicator, foreign exchange rate, physical commodity or interest rate for the player.

14. The apparatus of claim 12, where in the slot machine includes an input that permits selection of the security, market index, economic or financial market indicator, foreign exchange rate, physical commodity or interest rate, by the player.

15. The apparatus of claim of claim 12, wherein the random number generator generates five random digits that are shown on the row of the display when the slot machine spins.

16. The apparatus of claim 12, wherein three rows, each of which includes at least four random digits, are shown on the display when the slot machine spins.

17. The apparatus of claim 12, wherein the jackpot is a progressive jackpot.

18. The apparatus of claim 12, wherein the slot machine permits a player to spin the digits on the display again using the security, market index, economic or financial market indicator, foreign exchange rate, physical commodity or interest rate from an immediately previous spin.

19. The apparatus of claim 12, wherein the machine is a physical slot machine located in a casino.

20. The apparatus of claim 12, wherein the machine in a virtual slot machine implemented on-line over a computer network using a remote client computer accessed by the player and a server connected to the client computer over the computer network.

21. The apparatus of claim 12, wherein the machine pays the player a jackpot only if at least one of the random digits shown on the row matches a digit in positional correspondence thereto from the current value of the security, market index, economic or financial market indicator, foreign exchange rate, physical commodity or interest rate, when the digits on the display stop spinning.

22. An apparatus for conducting a game by a gambling operator or casino, comprising:
a machine that accepts a wager from a player;
a port in the machine that receives live financial market data;
a display coupled to the machine that shows the current value of a security, market index, economic or financial market indicator, foreign exchange rate, physical commodity or interest rate, wherein the current value includes at least four digits, and the current value is provided to the display using the live financial market data provided via the port;
a random number generator that generates at least four random digits that are shown on a row of the display when digits on the display spin; and
wherein the machine pays the player a jackpot if a plurality of the random digits shown on the row match digits representing the current value of the security, market index, economic or financial market indicator, foreign exchange rate, physical commodity or interest rate, when the digits on the display stop spinning.

23. The apparatus of claim 22, wherein the machine pays the player a jackpot only if a plurality of the random digits shown on the row match digits in positional correspondence thereto from the current value of the security, market index, economic or financial market indicator, foreign exchange rate, physical commodity or interest rate, when the digits on the display stop spinning.

24. The apparatus of claim 22, wherein the plurality of the random digits shown on the row that must match digits representing the current value of the security, market index, economic or financial market indicator, foreign exchange rate, physical commodity or interest rate when the digits on the display stop spinning in order for the machine to pay the player the jackpot, correspond to all of the random digits shown on the row.

25. The apparatus of claim 24, wherein the machine pays the player a jackpot only if all of the random digits shown on the row match digits in positional correspondence thereto from the current value of the security, market index, economic or financial market indicator, foreign exchange rate, physical commodity or interest rate, when the digits on the display stop spinning.

26. An apparatus for conducting a game by a gambling operator or casino, comprising:
a machine that accepts wagers from a plurality of players betting on a race, and assigns a security, market index, economic or financial market indicator, foreign exchange rate, physical commodity or interest rate to each player;
a port in the machine that receives live financial market data;
a display coupled to the machine that shows a plurality of securities, market indices, economic or financial market indicators, foreign exchange rates, physical commodities or interest rates, assigned to the players;
wherein the machine determines a winning security, market index, economic or financial market indicator, foreign exchange rate, physical commodity or interest rate, using the live financial market data, by identifying the security, market index, economic or financial market indicator, foreign exchange rate, physical commodity or interest rate shown on the display that increases in value the most by percentage during the race; and
wherein, at the end of the race, the machine pays winnings to each player assigned to the winning security, market index, economic or financial market indicator, foreign exchange rate, physical commodity or interest rate.

27. The apparatus of claim 26, wherein the machine accepts combination bets from each player, wherein said combination bets are selected from the group consisting of exactas, trifectas, daily double, pick three and pick six.

28. The apparatus of claim 26, wherein the machine is a physical machine located in a casino.

29. The apparatus of claim 26, wherein the machine in a virtual machine implemented on-line over a computer network using remote client computers accessed by the players and a server connected to the client computers over the computer network.

30. An apparatus for conducting a game by a gambling operator or casino, comprising:
a machine that accepts wagers from one or more players of the game;
a port in the machine that receives live financial market data;
a display coupled to the machine that shows a value of a security, market index, economic or financial market indicator, foreign exchange rate, physical commodity or interest rate, during a countdown period of the game;
wherein the display also shows a plurality of value ranges for the security, market index, economic or financial market indicator, foreign exchange rate, physical commodity or interest rate, and odds for each value range;
wherein each wager accepted by the machine corresponds to one of the plurality of value ranges;
wherein the machine determines a winning value range using the live financial market data by identifying the value range that the security, market index, economic or financial market indicator, foreign exchange rate, physical commodity or interest rate is within at the end of the game; and
wherein, at the end of the game, the machine pays winnings, in accordance with the odds, for each wager having a selected value range corresponding to the winning value range.

31. The apparatus of claim 30, wherein the machine accepts wagers for more than one value range from a single player.

32. The apparatus of claim 30, wherein the machine is a physical machine located in a casino.

33. The apparatus of claim 30, wherein the machine in a virtual machine implemented on-line over a computer network using remote client computers accessed by the players and a server connected to the client computers over the computer network.

34. The apparatus of claim 30, wherein each wager accepted by the machine corresponds to one of the plurality of value ranges selected by a player.

35. The apparatus of claim 30, wherein each wager accepted by the machine corresponds to one of the plurality of value ranges selected by the machine or a gambling operator.

36. An apparatus for conducting a game by a gaming sponsor, comprising:
a machine that accepts wagers from a plurality of players betting on a race;
a port in the machine that receives live financial market data;
a display coupled to the machine that shows a plurality of securities, market indices, economic or financial market indicators, foreign exchange rates, physical commodities or interest rates, and streaming financial data for each of the securities, market indices, economic or financial market indicators, foreign exchange rates, physical commodities or interest rates during a countdown period, where each of the wagers corresponds to one of the plurality of securities, market indices, economic or financial market indicators, foreign exchange rates, physical commodities or interest rates selected by a player;
wherein the machine determines a winning security, market index, economic or financial market indicator, foreign exchange rate, physical commodity or interest rate at the end of the race, using the live financial market data, by identifying the security, market index, economic or financial market indicator, foreign exchange rate, physical commodity or interest rate shown on the display that increases in value the most by percentage during the race; and
wherein, at the end of the race, the machine pays winnings on each wager that corresponds to the winning security, market index, economic or financial market indicator, foreign exchange rate, physical commodity or interest rate.

37. The apparatus of claim 36, wherein the machine accepts combination bets from each player, wherein said combination bets are selected from the group consisting of exactas, trifectas, daily double, pick three and pick six.

38. The apparatus of claim 36, wherein the machine is a physical machine located in a casino.

39. The apparatus of claim 36, wherein the machine in a virtual machine implemented on-line over a computer network using remote client computers accessed by the players and a server connected to the client computers over the computer network.

40. A method for conducting a game, comprising:
providing a deck of cards, wherein each card in the deck is associated with a symbol corresponding to one of a defined list of possible securities, market indices, economic or financial market indicators, foreign exchange rates, physical commodities or interest rates;
receiving an ante wager from each player;
after receipt of the ante wager from each player, assigning a portfolio of securities, market indices, economic or financial market indicators, foreign exchange rates, physical commodities or interest rates to each player and the house by dealing a plurality of cards from the deck to each player and the house, respectively;
after the cards are dealt, providing a betting round where each player is permitted to fold or raise their wager in the game;
after the betting round, using streaming financial data provided to the game to monitor a percentage increase in value in the portfolio of each player and the portfolio of the house during a race; and
at the end of the race, paying each player remaining in the game having a portfolio that increased by percentage more than the portfolio of the house.

41. The method of claim 40, wherein the cards are dealt face-down to the players, and at least one card is dealt face-up to the house.

42. The method of claim 40, wherein a player places a side bet against one or more other players.

43. The method of claim 40, wherein the game is played on a physical table located in a casino.

44. The method of claim 40, wherein the game is played on-line over a computer network using remote client computers accessed by the players and a server connected to the client computers over the computer network.

45. An apparatus for conducting a game, comprising:
a machine that accepts wagers from at least one player, wherein the wager is associated with a given security, market index, economic or financial market indicator, foreign exchange rate, physical commodity or interest rate, and includes a selected direction for a value of the given security, market index, economic or financial market indicator, foreign exchange rate, physical commodity or interest rate, and a number of consecutive predefined periods in which the value of the given security, market index, economic or financial market indicator, foreign exchange rate, physical commodity or interest rate will move in the selected direction;
a port in the machine that receives live financial market data;
a display coupled to the machine that shows streaming financial data for the given security, market index, economic or financial market indicator, foreign exchange rate, physical commodity or interest rate;
wherein the machine uses the live financial market data to monitor the value of the given security, market index, economic or financial market indicator, foreign exchange rate, physical commodity or interest rate during the game; and
wherein the machine pays winnings to the player if, during each of the consecutive predefined periods associated with the wager, the value of the given security, market index, economic or financial market indicator, foreign exchange rate, physical commodity or interest rate moves in the selected direction associated with the wager.

46. The apparatus of claim 45, wherein the machine accepts selections from the player corresponding to the given security, market index, economic or financial market indicator, foreign exchange rate, physical commodity or interest rate associated with the wager; the direction for the value of the given security, market index, economic or financial market indicator, foreign exchange rate, physical commodity or interest rate;
and the number of consecutive predefined periods in which the value of the given security, market index, economic or financial market indicator, foreign exchange rate, physical commodity or interest rate will move in the direction.

47. The apparatus of claim 45, wherein the machine selects the given security, market index, economic or financial market indicator, foreign exchange rate, physical commodity or interest rate associated with the wager; the direction for the value of the given security, market index, economic or financial market indicator, foreign exchange rate, physical commodity or interest rate; and the number of consecutive predefined periods in which the value of the given security, market index, economic or financial market indicator, foreign exchange rate, physical commodity or interest rate will move in the direction.

48. The apparatus of claim 45, wherein the machine is a physical machine located in a casino.

49. The apparatus of claim 45, wherein the machine in a virtual machine implemented on-line over a computer network using remote client computers accessed by the players and a server connected to the client computers over the computer network.

50. A method for conducting a game, comprising:
providing a forum where each player plays against other players by:
privately predicting before a round what a closing value of a given security, market index, economic or financial market indicator, foreign exchange rate, physical commodity or interest rate will be at the end of the round;
after making the private prediction, and during the round, having an opportunity to bet into a pot or fold; and
winning some or all of the pot if, at the end of the round, the private prediction of the player is closer to the closing value than any private prediction of any other player in the game or all other players have folded.

51. The method of claim 50, wherein players whose price predictions are the second and third closest to the actual closing value receive amounts from the pot

52. The method of claim 50, wherein, during the round, the player can buy a right to make a small change to their private prediction by adding a certain amount to the pot.

53. The method of claim 50, wherein the game is played on a physical table located in a casino.

54. The method of claim 50, wherein the game is played on-line over a computer network using remote client computers accessed by the players and a server connected to the client computers over the computer network.

55. A method for conducting a game where each player plays against other players, comprising:
providing a deck of cards, wherein each card in the deck is associated with a symbol corresponding to one of a defined list of possible securities, market indices, economic or financial market indicators, foreign exchange rates, physical commodities or interest rates;
receiving an ante wager from each player;
after receipt of the ante wager from each player, assigning a portfolio to each player by dealing a plurality of cards from the deck to each player;
after the cards are dealt, providing a betting round where each player is permitted to bet into a pot or fold;
after the betting round, using streaming financial data provided to the game to monitor a percentage increase in value in the portfolio of each player; and
awarding some or all of the pot to a player if, at the end of a predetermined period, the portfolio assigned to the player increased in value by percentage more than the portfolio of any other remaining player in the game or all other players have folded.

56. The method of claim 55, where some of the cards are dealt face-up, whereby a portion of each player's portfolio is revealed to the other players in the game.

57. The method of claim 55, further comprising awarding some of the pot to a player if, at the end of the predetermined period, the portfolio assigned to the player increased in value by percentage less than the portfolio of any other remaining player in the game.

58. The method of claim 55, wherein the game is played on a physical table located in a casino.

59. The method of claim 55, wherein the game is played on-line over a computer network using remote client computers accessed by the players and a server connected to the client computers over the computer network.

60. A method for conducting a game where each player plays against other players, comprising:
receiving a portfolio selection from each player, wherein the portfolio selection includes a plurality of securities, market indices, economic or financial market indicators, foreign exchange rates, physical commodities or interest rates selected from a fixed set of possibilities;
using streaming financial data provided to the game to monitor a percentage increase in value in the portfolio of each player; and
awarding some or all of a pot to a player if, at the end of a predetermined period, the portfolio selected by the player increased in value by percentage more than the portfolio of any other remaining player in the game or all other players have folded.

61. The method of claim 60, further comprising:
receiving an ante wager from each player;
after the portfolio selection is made by each player, providing a betting round where each player is permitted to bet into a pot or fold; and
after the betting round, using the streaming financial data provided to the game to monitor a percentage increase in value in the portfolio of each player.

62. The method of claim 60, wherein a portion of each player's portfolio is revealed to the other players in the game during or before the betting round.

63. The method of claim 60, further comprising awarding some of the pot to a player if, at the end of the predetermined period, the portfolio selected by the player increased in value by percentage less than the portfolio of any other remaining player in the game.

64. The method of claim 60, wherein the game is played on a physical table located in a casino.

65. The method of claim 60, wherein the game is played on-line over a computer network using remote client computers accessed by the players and a server connected to the client computers over the computer network.
